(19) United States
(12) Patent Application Publication
(10) Pub. No.: US 2022/0217322 A1
(43) Pub. Date: Jul. 7, 2022

(54) APPARATUS, ARTICLES OF MANUFACTURE, AND METHODS TO FACILITATE GENERATION OF VARIABLE VIEWPOINT MEDIA

(71) Applicant: Intel Corporation, Santa Clara, CA (US)

(72) Inventor: Santiago Alfaro, Campbell, CA (US)

(21) Appl. No.: 17/704,565

(22) Filed: Mar. 25, 2022

(51) Int. Cl. H04N 13/282; H04N 5/232; H04N 5/268; H04N 5/262; H04N 13/296

(52) U.S. Cl. CPC H04N 13/282; H04N 5/232935; H04N 5/268; H04N 13/296; H04N 5/232945; H04N 5/23245; H04N 5/2628

(57) ABSTRACT

Example apparatus disclosed herein are to cause display of first image data of a real-world scene captured by a first image sensor, the first image data providing a first perspective of the scene; cause display of second image data of the scene captured by a second image sensor, the second image data providing a second perspective of the scene, the second perspective different than the first perspective based on different positions of the first and second image sensors relative to the scene; cause display of a pivot axis line superimposed on at least one of the first image data or the second image data, the pivot axis line to indicate a point of rotation, within the scene, of variable viewpoint media to be generated based on the first and second image data; and cause the first and second image sensors to capture the image data for the variable viewpoint media.

### FIELD OF THE DISCLOSURE

This disclosure relates generally to capturing images and, more particularly, to apparatus, articles of manufacture, and methods to facilitate generation of variable viewpoint media.

### BACKGROUND

In recent years, light-field image sensors have been used to capture still images and/or videos along with light information (e.g., intensity, color, directional information, etc.) of scenes to dynamically change focus, aperture, and/or perspective while viewing the still images or video frames. In some instance, the light-field image sensors are used in multi-camera arrays to simultaneously capture still images, videos, and/or light information of object(s) (e.g., animate object(s), inanimate object(s), etc.) within a scene from various viewpoints. Some software applications, programs, etc. stored on a computing device can interpolate the captured still images and/or videos into a final variable viewpoint media output (e.g., a variable viewpoint image and/or a variable viewpoint video). A user or a viewer of such variable viewpoint media can switch between multiple perspectives during a presentation of the variable viewpoint image and/or the variable viewpoint video such that the transition between image sensor viewpoints appears seamless to the user or viewer.

### BRIEF DESCRIPTION OF THE DRAWINGS

FIG. 1A illustrates a top-down view of an example system to capture and/or generate variable viewpoint media in accordance with teachings disclosed herein.

FIG. 1B illustrates a side view of the example system of FIG. 1A.

FIG. 2 is a block diagram of an example implementation of the example computing device of FIGS. 1A and 1B.

FIG. 3 illustrates an example device set-up graphic of a graphical user interface for generating variable viewpoint media.

FIG. 4 illustrates a first example scene set-up graphic of the graphical user interface for generating variable viewpoint media.

FIG. 5 illustrates a second example scene set-up graphic of the graphical user interface for generating variable viewpoint media.

FIG. 6 illustrates a third example scene set-up graphic of the graphical user interface for generating variable viewpoint media.

FIG. 7 illustrates an example pivoting preview graphic of the graphical user interface for generating variable viewpoint media.

FIG. 8 an example capture graphic of the graphical user interface for generating variable viewpoint media.

FIG. 9 illustrates an example post-capture graphic of the graphical user interface for generating variable viewpoint media.

FIGS. 10-13 are flowcharts representative of example machine readable instructions and/or example operations that may be executed by the example computing device of FIGS. 1A, 1B, and/or 2 to facilitate generation of variable viewpoint media.

FIG. 14 is a block diagram of an example processing platform including processor circuitry structured to execute the example machine readable instructions and/or the example operations of FIGS. 10-13 to implement the example computing device of FIGS. 1A, 1B, and/or 2.

FIG. 15 is a block diagram of an example implementation of the processor circuitry of FIG. 14.

FIG. 16 is a block diagram of another example implementation of the processor circuitry of FIG. 14.

FIG. 17 is a block diagram of an example software distribution platform (e.g., one or more servers) to distribute software (e.g., software corresponding to the example machine readable instructions of FIGS. 10-13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

Light-field image sensors can be used to capture information, such as intensity, color, and direction, of light emanating from a scene, whereas conventional cameras capture only the intensity and color of the light. In some examples, a single light-field image sensor can include an array of micro-lenses in front of a conventional camera lens to collect the direction of light in addition to the intensity and color of the light. Due to the array of micro-lenses and the light information gathered, the final output image and/or video that the image sensor captures can be viewed from various viewpoints and with various focal lengths. Three-dimensional images can also be generated based on the information that the light-field image sensors capture.

In some examples, a multi-camera array of multiple (e.g., 2, 3, 5, 9, 15, 21, etc.) image sensors is used to simultaneously capture a scene and/or an object within the scene from various viewpoints corresponding to different ones of the image sensors. Capturing light information from the different viewpoints of the scene enable the direction of light emanating from the scene to be determined such that the image sensors in the multi-camera array collectively operate as a light-field image sensor system. The multiple images and/or videos that the image sensors simultaneously capture can be combined into variable viewpoint media (e.g., a variable viewpoint image and/or a variable viewpoint video) which can be viewed from the multiple perspectives of the image sensors of the multi-camera array. That is, in some examples, the user and/or the viewer of variable viewpoint media can switch perspectives or viewing angles of the scene represented in the media based on the different perspective or angles from which images of the scene were captured by the image sensors. In some examples, intermediate images can be generated by interpolating between images captured by adjacent image sensors in the multi-camera array so that the transition from a first perspective to a second perspective is effectively seamless. Variable viewpoint media is also sometimes referred to as free viewpoint media.

In some examples, the multi-camera array includes a rigid framework to support different ones of the image sensors in a fixed spatial relationship so that a user can physically set up in a room, stage, outdoor area, etc. relatively quickly. The example multi-camera array includes image sensors positioned in front of and around the object within the scene to be captured. For example, a first image sensor in the center of the multi-camera array, may face a front side of the object while a second image sensor on the peripheral of the multi-camera array may face a side of the object. The image sensors have individual fields of view that include the extent of the scene that an individual image sensor of the multi-camera array can capture. The volume of space where the individual fields of view of the image sensors in the multi-camera array overlap is referred to herein as the “region of interest”.

As a viewer transitions variable viewpoint media between different perspectives, the images and/or video frames appear to rotate about a pivot axis within the region of interest. The pivot axis is a virtual point of rotation of the variable viewpoint media and is the point at which the front of the object of the scene is to be placed so the variable viewpoint media includes every side of the object that the image sensors capture. If the object were not to be positioned at the pivot axis, then unappealing or abrupt shifts to the object's location in the scene relative to the image sensors may occur when transitioning between image sensor perspectives.

Some existing multi-camera array installments call for specialists to set-up the scene (e.g., the room, stage, etc.) and the object (e.g., the person, inanimate object, etc.) within the scene such that the object is positioned precisely at the pivot axis. If the object were to move from that point, then the multi-camera array would need to be repositioned and/or recalibrated to ensure that the object is correctly oriented. Alternatively, if a new object were to be captured, then the object would need to be brought to the scene rather than the multi-camera array brought to the object. Since the multi-camera array would have a static pivot axis and region of interest, the location of the pivot axis and the volume of the region of interest would limit the size of the object to be captured.

Existing software used to capture multiple viewpoints with a multi-camera array can control the capture of images and/or videos from various perspectives but treat each image sensor in the multi-camera array as an individual source. In other words, switching between viewpoints in output media could not be done dynamically on a first viewing. Furthermore, the different angles or perspectives of the different image sensors are not considered in combination prior to image capture. Thus, the user of such software needs to edit the multiple perspectives individually to combine them together in a synchronized manner as subsequent processing operations before it is possible to view variable viewpoint media from different perspectives.

In examples disclosed herein, a computing device causes a graphical user interface to display images that image sensors in a multi-camera array capture, thus allowing a user of the graphical user interface to inspect multiple perspectives of the multi-camera array prior to capture or to review the multiple perspectives of the multi-camera array post capture and before generation of particular variable viewpoint media content. In examples disclosed herein, the computing device causes the graphical user interface to adjust a pivot axis of the variable viewpoint media, thus allowing the user to dynamically align the pivot axis with a location of an object in a scene. Additionally or alternatively, in examples disclosed herein, the graphical user interface provides an indication of the location of the pivot axis to facilitate a user to position an object at the pivot axis through a relatively simple inspection of the different perspectives of the region of interest associated with the different image sensors in the multi-camera array. In examples disclosed herein, the computing device causes the graphical user interface to generate a pivoting preview of the variable viewpoint media prior to capture, thereby enabling the user to determine if the object is properly aligned with the pivot axis before examining the variable viewpoint media post capture.

Examples disclosed herein facilitate quicker and more efficient set-up of the scene to be captured relative to example variable viewpoint media generating systems mentioned above that do not implement the graphical user interface disclosed herein. The example graphical user interface disclosed herein further allows more dynamic review of the final variable viewpoint media output relative to the example software mentioned above.

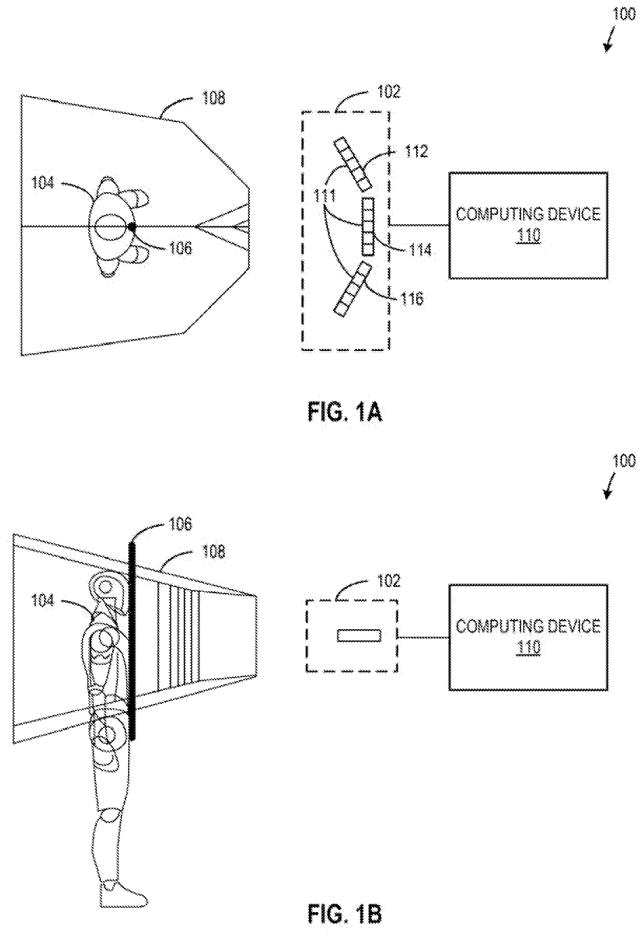

Referring now to the figures, FIG. 1A is an example schematic illustration of a top-down view of an example system 100 that includes a multi-camera array 102 (“array 102”) to capture images and/or videos of a scene that are to be used as the basis for variable viewpoint media. FIG. 1B is an example illustration of a side view of the example system 100 of FIG. 1A. As shown in the illustrated example, the system 100 is arranged to capture images of an object 104 within the scene. As represented in FIGS. 1A and 1B, the object 104 is located at a pivot axis line 106 within a region of interest 108. The example system 100 also includes a computing device 110 to store and execute a variable viewpoint capture application. The computing device 110 includes user interface execution circuitry to implement a graphical user interface with which a user can interact and send inputs to the array 102, the variable viewpoint capture application, and/or the computing device 110.

The example system 100 illustrated in FIGS. 1A and/or 1B includes the array 102 to capture image(s) (e.g., still image(s), videos, image data, etc.) of the scene and/or light information (e.g., intensity, color, direction, etc.) of light emanating from the scene. As used herein, the “scene” that the multi-camera array 102 is to capture includes the areas and/or volumes of space in front of the array 102 and within the field(s) of view of one or more of the image sensors included in the array 102. For example, if the object 104 were to be positioned in a location that is outside of the scene, then the image sensors included in the array 102 would not capture image(s) of the object 104. The example array 102 is to capture image(s) and/or videos of the scene, including the region of interest 108 and/or the object 104, in response to an input signal from the computing device 110.

In some examples, the multi-camera array 102 includes multiple image sensors 111 positioned next to one another in a fixed framework and/or in subset frameworks included a fixed framework assembly. In the illustrated example of FIGS. 1A and 1B, there are three individual frameworks 112, 114, 116 that each includes five image sensors 111 for a total of fifteen sensors across the entire array 102. In some examples, the first framework 112, the second framework 114, and the third framework 116 include more or less than five image sensors 111 each. In some examples, the first framework 112, the second framework 114, and the third framework 116 include different numbers of image sensors 111. In some examples, the array 102 may include more or less than fifteen total image sensors 111. In some examples, the array 102 may include more or less than three subset frameworks included in the fixed framework assembly. The image sensors 111 in the example array 102 are to point toward the scene from various perspectives. For example, the example second (middle) framework 114 is positioned to point toward the scene to capture a forward-facing viewpoint of the object 104. More particularly, a central image sensor 111 in the middle framework 114 is directly aligned with and/or centered on the object 104. The example first framework 112 and the example third framework 116 are positioned on either side of the second framework and angled toward the scene. The position of the example first framework 112 and the example third framework 116 enable the array 102 to capture side-facing viewpoints of the object 104.

The region of interest 108 represented in FIGS. 1A and 1B depicts a volume of space in the scene that the image sensors 111 of the array 102 that is common to the fields of view of all of the image sensors 111. Thus, the region of interest 108 corresponds to the three-dimensional volume of the scene that the image sensors 111 can collectively capture. The example region of interest 108 illustrated in FIGS. 1A and 1B is a representation of a region of interest of the array 102 and is not physically present in the scene. For example, if the object 104 were to be positioned in a location within the scene but outside of the region of interest 108, at least one of the image sensors 111 included in the array 102 would not be able to capture image(s) of the object 104. The geometric dimensions of the example region of interest 108 illustrated in FIGS. 1A and 1B may be dependent on the properties (e.g., size, etc.) of the image sensors, the number of image sensors in the array 102, the spacing between the image sensors in the array 102, and/or the orientation of the subset frameworks (e.g., the first framework 112, the second framework 114, the third framework 116, etc.) of the array 102.

The example pivot axis line 106 represented in FIGS. 1A and 1B depicts a pivot axis about which variable viewpoint media generated from images captured by the image sensors 111 appears to rotate. The example pivot axis line 106 illustrated in FIGS. 1A and 1B is a representation of the pivot axis and is not physically present in the scene. As discussed previously the example pivot axis line 106 indicates a point of rotation of the variable viewpoint media. For example, the variable viewpoint media is to rotate about the pivot axis line 106 such that when a viewer of the variable viewpoint media transitions between different perspectives of the image sensors included in the multi-camera array, the variable viewpoint media will show the scene as if a single image sensor was dynamically moving around the scene while the single image sensor rotates so that the gaze remains fixed at the pivot axis.

The example object 104 illustrated in FIGS. 1A and 1B is an adult human, however, in some examples, the object 104 may be another animate object (e.g., an animal, a child, etc.), a motionless inanimate object (e.g., a chair, a sphere, etc.), or a moving inanimate object (e.g., a fire, a robot, etc.). To generate variable viewpoint media that is focused on and appears to rotate about the object, the example object 104 should be aligned with the pivot axis line 106. In some examples, the object 104 is aligned with the pivot axis such that the pivot axis is located at the front of the object 104, as shown in the illustrated example. In other examples, the object 104 can be aligned with the pivot axis so that the pivot axis line extends directly through the object (e.g., a center or any other part of the object). The object 104 may alternatively be placed at a location that is offset relative to the pivot axis if so desired, but this would result in variable viewpoint media in which the object 104 appears to move and rotate about an axis offset from the object.

The example system 100 of FIGS. 1A and 1B includes the computing device 110 to control the image sensors 111 in the array 102 and store an example software application to facilitate a user in using the array 102 to generate variable viewpoint media. In some examples, the computing device 110 may be a personal computing device, a laptop, a smartphone, a tablet computer, etc. The example computing device 110 may be connected to the multi-camera array 112 via a wired connection or a wireless connection, such as via a Bluetooth or a Wi-Fi connection. Further details of the structure and functionality of the example computing device 110 are described below.

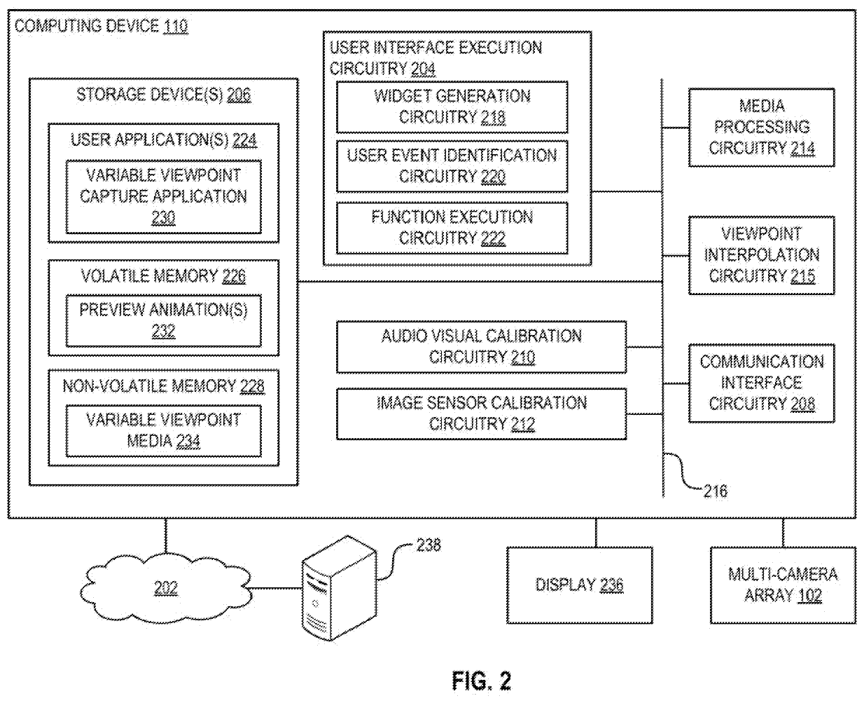

FIG. 2 is a block diagram of an example implementation of the example computing device 110 of FIGS. 1A and 1B. The computing device 110 of FIG. 2 may be instantiated (e.g., creating an instance of, bring into being for any length of time, materialize, implement, etc.) by processor circuitry such as a central processing unit executing instructions. Additionally or alternatively, the computing device 110 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor.

As represented in the illustrated example of FIG. 2, the computing device 110 is communicatively coupled to the array 102 and a network 202. The example computing device 110 of the example computing device 110 illustrated in FIG. 2 includes example user interface execution circuitry 204, example storage device(s) 206, example communication interface circuitry 208, example audio visual calibration circuitry 210, example image sensor calibration circuitry 212, example media processing circuitry 214, example viewpoint interpolation circuitry 215, and an example bus 216 to communicatively couple the components of the computing device 110. The example user interface execution circuitry 204 of FIG. 2 includes example widget generation circuitry 218, example user event identification circuitry 220, and example function execution circuitry 222. The example storage device(s) 206 of FIG. 2 include example user application(s) 224, example volatile memory 226, and example non-volatile memory 228. The example user application(s) 224 includes an example variable viewpoint capture application 230, the example volatile memory 228 includes example preview animation(s) 232, and the example non-volatile memory 228 includes variable viewpoint media 234. The example computing device 110 is connected to an example display 236 (e.g., display screen, projector, headset, etc.) via a wired and/or wireless connection to display captured image(s) and/or video(s) and generated variable viewpoint media. In some examples, the display 236 is located on and/or in circuit with the computing device 110. The example computing device 110 may include some or all of the components illustrated in FIG. 2 and/or may include additional components not shown.

The example computing device 110 is communicatively coupled to the network 202 to enable the computing device 110 to send saved variable viewpoint media 234, stored in example non-volatile memory 228, to an external device and/or server 238 for further processing. Additionally or alternatively, in some examples, the external device and/or server 238 may perform the image processing to generate the variable viewpoint media 234. In such examples, the computing device 110 sends images captured by the image sensors 111 to the external device and/or server 238 over the network 202 and then receives back the final variable viewpoint media 234 for storage in the example non-volatile memory 228. In other examples, the external device and/or server 238 may perform only some of the image process and the processed data is then provided back to the computing device 110 to complete the process to generate the variable viewpoint media 234.

The example network 202 may be a wired (e.g., a coaxial, a fiber optic, etc.) or a wireless (e.g., a local area network, a wide area network, etc.) connection to an external server (e.g., server 238), device, and/or computing facility. In some examples, the computing device 110 uses the communication interface circuitry 208 (e.g., a network interface controller, etc.) to transmit the variable viewpoint media 234 (and/or image data on which the variable viewpoint media 234 is based) to another device and/or location. Once uploaded to the server 238 via the network 202, an example user may interact with a processing service via the communication interface circuitry 208 and/or the network 202 to edit the variable viewpoint media 234 with software not stored on the computing device 110. Additionally or alternatively, the user of the example computing device 110 may not transmit the variable viewpoint media 234 to the external server and/or device via the network 202 and may edit the variable viewpoint media 234 with software application(s) stored in one or more storage devices 206.

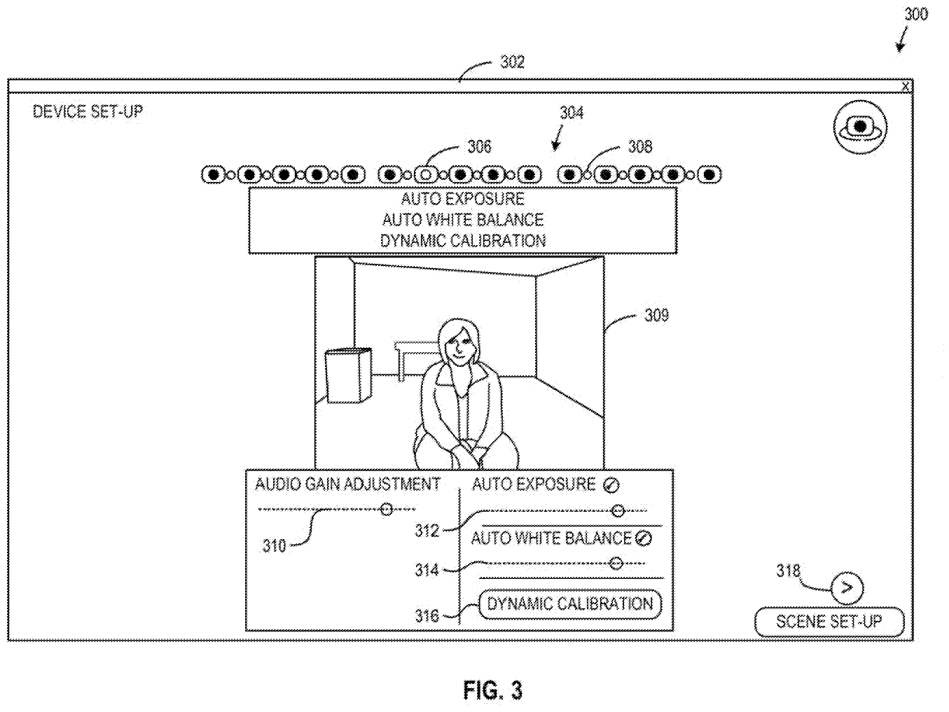

The example computing device 110 illustrated in FIG. 2 includes the user interface execution circuitry 204 to implement a graphical user interface (GUI) presented on the display 236 to enable one or more users to interact with the computing device 110 and the multi-camera array 102. Example graphics or screenshots of the GUI are shown and described further below in connection with FIGS. 3-9. The example user may interact with the GUI to calibrate the image sensors 111 in the array 102, set-up the scene including, in particular, the position of the object 104 to be captured by the image sensors 111, adjust the pivot axis line 106, generate the preview animation(s) 232, capture images used to generate the variable viewpoint media 234, and/or process and/or generate the variable viewpoint media 234. The example user interface execution circuitry 204 generates the GUI graphics, icons, prompts, backgrounds, buttons, displays, etc., identifies user events based on user inputs to the computing device 110, and executes functions of the example variable viewpoint capture application 230 based on the user events and/or inputs.

The example user interface execution circuitry 204 includes the widget generation circuitry 218 to generate graphics, windows, and widgets of the GUI for display on the display 236 (e.g., monitor, projector, headset, etc.). The term “graphics” used herein refers to the portion(s) of the display screen(s) that the computing device 110 is currently allocating to the GUI based on window(s) and widget(s) that are to be displayed for the current state of the GUI. The term “widget(s)” used herein refers to interactive elements (e.g., icons, buttons, sliders, etc.) and non-interactive elements (e.g., prompts, windows, images, videos, etc.) in the GUI. The example widget generation circuitry 218 may send data, signals, etc. to external output device(s) via wired or wireless connections and the communication interface circuitry 208. Additionally or alternatively, the example output device(s) (e.g., display screen(s), touchscreen(s), etc.) may be mechanically fixed to a body of the computing device 110.

In some examples, the widget generation circuitry 218 receives signals (e.g., input signals, display signals, etc.) from the communication interface circuitry 208, the media processing circuitry 214, the function execution circuitry 222, and/or the variable viewpoint media 234. For example, the user may interact with the GUI to set up a scene and/or adjust a position of the pivot axis line 106 prior to capturing images of the scene to be used to generate variable viewpoint media. The example communication interface circuitry 208 receives inputs from the user via any suitable input device (e.g., a mouse or other pointer device, a stylus, a keyboard, a touchpad, a touchscreen, a microphone, etc.) and sends input data to the example widget generation circuitry 218 that indicate how a first widget (e.g., a slider, a number, a percentage, etc.) should change based on the user input. The example widget generation circuitry 218 sends pixel data to an output device (e.g., monitor, display screen, headset, etc.) via the communication interface circuitry 208 that signal the changed graphics of the widget to be displayed.

The example user interface execution circuitry 204 includes the user event identification circuitry 220 to detect user events that occur in the GUI via the communication interface circuitry 208. In some examples, the user event identification circuitry 220 receives a stream of data from the widget generation circuity 218 that includes the current types, locations, statuses, etc. of the widgets in the GUI. The example user event identification circuitry 220 receives input data from the communication interface circuitry 208 based on user inputs to a mouse, keyboard, stylus, etc. Depending on the type of user input(s) to the widgets (e.g., icons, buttons, sliders, etc.) currently being displayed, the example user event identification circuitry 220 may recognize a variety of user event(s) occurring, such as an action event (e.g., a button click, a menu-item selection, a list-item selection, etc.), a keyboard event (e.g., typed characters, symbols, words, numbers etc.), a mouse event (e.g., mouse clicks, movements, presses, releases, etc.) including the mouse pointer entering and exiting different graphics, windows, and/or widgets of the GUI.

The example user interface execution circuitry 204 of the computing device 110 includes the function execution circuitry 222 to determine the function and/or tasks to be executed based on the user event data provided by the user event identification circuitry 220. In some examples, the function execution circuitry 222 executes machine-readable instructions and/or operations of the variable viewpoint capture application 230 to control execution of functions associated with the GUI. Additionally or alternatively, the function execution circuitry 222 executes machine-readable instructions and/or operations of other software programs and/or applications stored in the storage device(s) 206, servers 238, and/or other external storage device(s). The example function execution circuitry 222 can send commands to other circuitry (e.g., audio visual calibration circuitry 210, image sensor calibration circuitry 212, etc.) instructing which functions and/or operations to perform to a certain parameter.

The example computing device 110 illustrated in FIG. 2 includes the storage device(s) 206 to store and/or save the user application(s) 224, the preview animation(s) 232, and/or the variable viewpoint media 234. The example user application(s) 224 may be stored in an external storage device (e.g., server 238, external hard drive, flash drive, compact disc, etc.) or in the non-volatile memory 228, such as hard disk(s), flash memory, erasable programmable read-only memory, etc. The example user application(s) 224 illustrated in FIG. 2 include the variable viewpoint capture application 230. In some examples, the user application(s) 224 include additional and/or alternative software application(s). The example variable viewpoint capture application 230 includes machine-readable instructions that the computing device 110 and/or the user interface execution circuitry 204 uses to implement the GUI to capture image(s) and/or video(s) to generate the preview animation(s) 232 and/or the variable viewpoint media 234.

The example storage device(s) 206 of the computing device 110 includes volatile memory 226 to store and/or save the preview animation(s) 232 that the media processing circuitry 214 generates. In some examples, the volatile memory 226 may include dynamic random access memory, static random access memory, dual in-line memory module, etc. to store the preview animation(s) 232, the variable viewpoint media 234, and/or other media or data from the user application(s) 224 and/or components of the computing device 110.

The example storage device(s) 206 of the computing device 110 includes non-volatile memory 228 to store and/or save the variable viewpoint media 234 that the function execution circuitry 222 and/or the media processing circuitry 214 generates. In some examples, the non-volatile memory 228 may include electrically erasable programmable read-only memory (EEPROM), FLASH memory, a hard disk drive, a solid state drive, etc. to store the preview animation(s) 232, the variable viewpoint media 234, and/or other media or data from the user application(s) 224 and/or components of the computing device 110.

The example computing device 110 illustrated in FIG. 2 includes the communication interface circuitry 208 to communicatively couple the computing device 110 to the network 202 and/or the display 236. In some examples, the communication interface circuitry 208 establishes wired (e.g., USB, etc.) or wireless (e.g., Bluetooth, etc.) connection(s) with output device(s) (e.g., display screen(s), speaker(s), projector(s), etc.) and sends output signals that the media processing circuitry 214 generates via example processing circuitry (e.g., central processing unit, ASIC, FPGA, etc.).

The example computing device 110 illustrated in FIG. 2 includes the audio visual calibration circuitry 210 to control and/or adjust the audio settings of microphone(s) on and/or peripheral to the array 102. The example audio visual calibration circuitry 210 can change gain level(s) of one or more microphones based on user input to the GUI, input data received from the communication interface circuitry 208, and/or commands received from the function execution circuitry 222. In some examples, the audio visual calibration circuitry 210 performs other calibration and/or equalization techniques for the microphone(s) of the array 102 that are known to those with common skill in the art. The example audio visual calibration circuitry 210 can also control and/or adjust the video settings of the image sensor(s) 111 on the array 102. The example audio visual calibration circuitry 210 can change the exposure level(s) and/or white balance level(s) of one or more image sensors 111 based on user input to the GUI, input data received from the communication interface circuitry 208, and/or commands received from the function execution circuitry 222. The example audio visual calibration circuitry 210 can also automatically adjust the exposure levels and/or the white balance levels of multiple image sensors 111 to match adjustments made to video settings of one image sensor. The example computing device 110 illustrated in FIG. 2 includes the image sensor calibration circuitry 212 to perform dynamic calibration and/or other calibration techniques for the image sensor(s) of the array 102. Dynamic calibration, as referred to herein, is a process of automatically determining a spatial relationship of the image sensor(s) of the array 102 to each other and a surrounding environment. Typically, an image sensor positions fiducial markers (e.g., a checkerboard pattern) at particular locations within a field of view of the image sensor and analyzes the size and shape of the markers from the perspective of the image sensor to determine the position of the image sensor relative to the markers and, by extension, to the surrounding environment in which the markers are placed. Dynamic calibration performs this process automatically without the markers by relying on analysis of images of the scene (e.g., by identifying corners of walls, ceilings, and the like to establish a reference frame).

The example computing device 110 illustrated in FIG. 2 includes the media processing circuitry 214 to sample a video stream and/or individual images that the image sensors of the array 102 output. In some examples, the media processing circuitry 214 crops, modifies, down samples, and/or reduces a frame rate of the video stream signal to generate a processed video stream. The example media processing circuitry 214 stores the processed video stream in the example storage device(s) 206, such as volatile memory 226 where the example user interface execution circuitry 204 and/or the communication interface circuitry may retrieve the processed video stream.

In some examples, the media processing circuitry 214 crops and/or modifies the pixel data of the video stream(s) received from one or more image sensors. The example media processing circuitry 214 may crop and/or manipulate the video stream(s) based on user input data from the communication interface circuitry 208 and/or command(s) from the function execution circuitry 222. Further details on the cropping(s) and/or modification(s) that the media processing circuitry 214 performs are described below.

The example computing device 110 illustrated in FIG. 2 includes the viewpoint interpolation circuitry 215 to generate intermediate images corresponding to perspectives positioned between different adjacent ones of the image sensors 111 in the array 102 based on an interpolation of pairs of images captured by the adjacent ones of the image sensors 111. Additionally or alternatively, the communication interface circuitry 208 may send the captured image data to the server 238 via the network 202 for interpolation. The intermediate images generated through interpolation enables for smooth transition between different perspectives in resulting variable viewpoint media generated based on such images. The example interpolation methods that the viewpoint interpolation circuitry 215 perform include any technique now known or subsequently developed.

FIG. 3 is an example illustration of a device set-up graphic 300 of the GUI for generating variable viewpoint media. The example device set-up graphic 300 is a portion of the GUI with which the user interacts to calibrate audio and/or visual settings of the microphone(s) and/or image sensor(s) 111 in the array 102 of FIGS. 1A, 1B, and/or 2. In some examples, the user of the computing device 110 launches the variable viewpoint capture application 230, and the widget generation circuitry 218 of FIG. 2 generates and renders the graphic(s), window(s), and widgets of the device set-up graphic 300 illustrated in FIG. 3.

The example device set-up graphic 300 illustrated in FIG. 3 includes an example device set-up window 302 (“window 302”) to frame widgets used for setting up the array 102. In some examples, the widget generation circuitry 218 executes instructions of the variable viewpoint capture application 230 to provide pixel data of the window 302 and the included widgets to the communication interface circuitry 208. In some examples, communication interface circuitry 208 transmits the pixel data to the display 236. In some examples, the window 302 is the only window of the device set-up graphic 300. In some other examples, the device set-up graphic 300 includes more than one window 302 to frame the widgets used for setting up the array 102.

The example device set-up graphic 300 illustrated in FIG. 3 includes an example perspective control panel 304 (“panel 304”) to enable the user to choose an image sensor viewpoint of the array 102. The example panel 304 includes example image sensor icons 306 and example microphone level indicators 308. In this example, the panel 304 includes fifteen image sensor icons 306 in three groups of five that correlate with the three frameworks 112, 114, 116 of five image sensors 111 included in the example array 102. In some examples, as the user clicks or otherwise indicates a selection of a particular one of the image sensor icons 306, a video feed associated with the corresponding image sensor 111 is displayed within a preview area 309 of the device set-up graphic 300. In some examples, the selected image sensor icon 306 includes a visual indicator (e.g., a color, a highlighting, a discernable size, etc.) to emphasize which image sensor 111 is currently being previewed in the preview area 309. As shown in the illustrated example, the image sensor 111 that is immediately to the left of the center image sensor is selected for preview. In some examples, the panel 304 includes more or less than fifteen image sensor icons 306 based on the number of image sensor(s) included in an example array 102. The example panel 304 includes twelve microphone level indicators 308 correlating with twelve microphones installed in the example array 102. In some examples, the panel 304 includes more or less than twelve microphone level indicators 308 based on the number of microphone(s) included in an example array 102.

In some examples, the user and/or the object 104 create test sounds in the scene for the microphones to sense. The color of one or more example microphone level indicators 308 may change from green to red if an audio gain setting for the microphone(s) is not properly calibrated. In some examples, the microphone level indicators 308 change into more colors than green and red, such as yellow, orange, etc., to indicate gradual levels of distortion and/or degradation of audio quality due to improper audio gain levels. The example device set-up graphic 300 includes an example audio gain adjustment slider 310 to cause the audio visual calibration circuitry 210 to change audio gain level(s) of one or more microphones of the array 102 in response to user input. In some examples, the audio gain adjustment slider 310 is used to control the audio gain level(s) of microphones adjacent to the particular image sensor 111 selected for preview in the preview area 309. Thus, in some examples, different ones of the image sensor icons 306 need to be selected to adjust the audio gain level(s) for different ones of the microphones.

The example device set-up graphic 300 illustrated in FIG. 3 includes an example auto exposure slider 312 to cause the image sensor calibration circuitry 212 to change an exposure level of the selected image sensor 111 of the array 102 in response to user input. In some examples, the communication interface circuitry 208 also sends signal(s) to the image sensor calibration circuitry 212 to adjust the aperture size of the image sensor 111 corresponding to the image sensor icon 306 selected on the panel 304 based on the user input.

The example device set-up graphic 300 illustrated in FIG. 3 includes an example auto white balance slider 314 to cause the image sensor calibration circuitry 212 to adjust the colors, tone, and/or white balance settings of the selected image sensor 111 of the array 102 in response to user input. In some examples, the example communication interface circuitry 208 and/or the function execution circuitry 222 sends signal(s) to the image sensor calibration circuitry 212 to adjust the color, tone, and/or white balance settings of the selected image sensor 111.

The example device set-up graphic 300 illustrated in FIG. 3 includes an example dynamic calibration button 316 to cause image sensors of the array 102 to determine the positions of the image sensors in space relative to each other and relative to the scene. In some examples, the example image sensor calibration circuitry 212 performs dynamic calibration for all of the image sensors 111 of the array 102, as described above, in response to user selection of the dynamic calibration button 316. Additionally or alternatively, user selection of the dynamic calibration button 316 initiates calibration of the particular image sensor 111 corresponding to the image sensor icon 306 selected in the panel 304

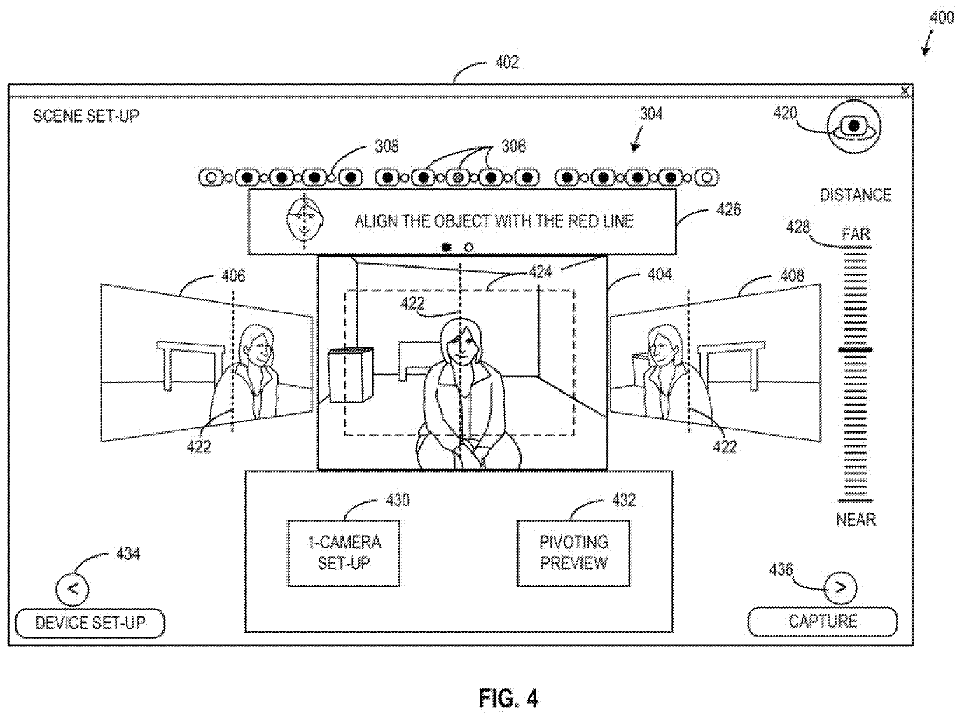

The example device set-up graphic 300 illustrated in FIG. 3 includes an example scene-set up button 318 to cause the GUI to proceed to a subsequent graphic for setting up the scene of the variable viewpoint media, as described below in connection with FIGS. 4-6. In some examples, the user of the GUI selects the scene set-up button 318 via an input device to cause the user interface circuitry 204 to generate the next graphic and load the scene set-up functionality of the variable viewpoint capture application 230.

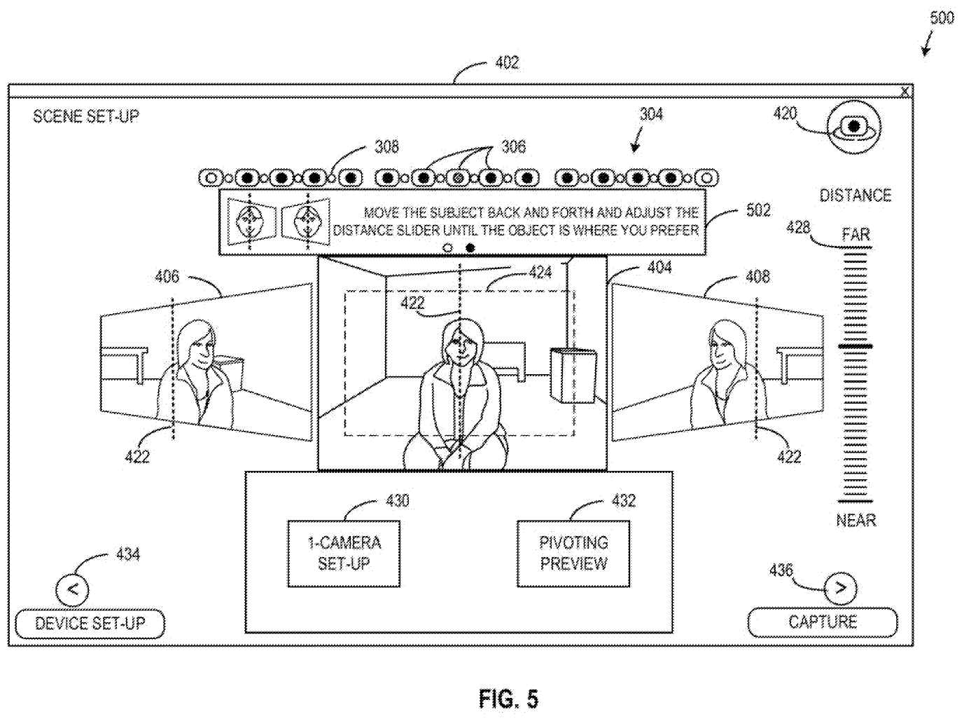

FIGS. 4 and 5 are example illustrations of first and second scene set-up graphics 400, 500 of the GUI for generating variable viewpoint media. The example first scene set-up graphic 400 of FIG. 4 depicts a selfie mode of a scene set-up portion of the GUI, whereas the second scene set-up graphic 500 of FIG. 5 depicts a director mode of the scene set-up portion of the GUI. These scene set-up graphics facilitate a user in aligning the object 104 with the pivot axis line 106 and/or adjusting a location of the pivot axis line 106 in the scene. More particularly, as described further below, the object 104 in the selfie mode (FIG. 4) is assumed to be the user, whereas the object 104 in the director mode (FIG. 5) is assumed to be something other than the user (e.g., a different person or other object). In some examples, the widget generation circuitry 218 generates and/or renders the graphic(s), window(s), and widgets of the first scene set-up graphic 400, 500 in response to activation and/or selection of the scene set-up button 318 of FIG. 3.

The example scene set-up graphics 400, 500 illustrated in FIGS. 4 and 5 include an example scene set-up window 402 (“window 402”) to frame widgets used for setting up the scene to be captured in the variable viewpoint media. In some examples, the window 402 is generated and displayed in a same and/or similar way as the window 302, described above. In some examples, the first scene set-up graphic 400, 500 includes more than one window 402 to frame the widgets used for setting up scene to be captured in the variable viewpoint media.

The example scene set-up graphics 400, 500 illustrated in FIGS. 4 and 5 include an example center image frame 404, an example first side image frame 406, and an example second side image frame 408 to display the perspectives of the images, videos, and/or pixel data that three image sensors 111 of the array 102 capture. In some examples, the video feeds of the particular image sensors 111 previewed in the three image frames 404, 406, 408 are determined by a user selecting different ones of the image sensor icons 306 of the panel 304. In the example shown in FIG. 4, the center image frame 404 provides a preview of a video feed from the central image sensor 111 of the array 102 (e.g., an eighth image sensor of fifteen total image sensors) and the first and second side image frames 406 provide previews of the video feeds from the outermost image sensors 111 of the array 102. While three image frames 404, 406, 408 are shown in the illustrated example, in other examples, only two image frames may be displayed. In other examples, more than three image frames corresponding to more than three user selected image sensors may be displayed.

In some examples, the center image frame 404 is permanently fixed with respect to the central image sensor 111 such that a user is unable to select a different image sensor to be previewed within the center image frame 404. In this manner, the object 104 (e.g., the person, etc.) that is to be the primary focus of the variable viewpoint media will be centered with the array 102 with the central image sensor 111 directly facing toward the object 104. In some examples, the image sensor icon 306 corresponding to the central image sensor has a different appearance than the selected buttons associated with the other images sensors selected for preview on either side of the central image sensor and has a different appearance than the non-selected buttons 306 in the panel 304. cameras. For instance, in some examples, the central image sensor icon 306 may be greyed out, have a different color (e.g., red), include an X, or some other indication to indicate it cannot be selected or unselected. In other examples, different image sensor icons 306 other than the central button can be selected to identify the video feed for a different image sensor to be previewed in the center image frame 404. Whether or not the center image frame 404 is fixed with respect to the central image sensor 111, in some examples, a user can select any one of the other buttons on either side of the image sensor associated with the center image frame 404 to select corresponding video feeds to be previewed in the side image frames 406, 408.

The example scene set-up graphics 400, 500 illustrated in FIGS. 4 and 5 include an example perspective invert button 420 to cause the widget generation circuitry 218 to change between the first scene set-up graphic 400 of FIG. 4 associated with the selfie mode and the second scene set-up graphic 500 of FIG. 5 associated with the director mode. The term “selfie mode” is used herein to refer to an orientation, layout, and/or mirrored quality of the image(s) displayed in the center image frame 404, the first side image frame 406, and the second side image frame 408. More particularly, in some examples, the selfie mode represented in the first scene set-up graphic 400 is intended for situations in which the object 104 that is to be the focus of variable viewpoint media corresponds to the user of the system 100A-B of FIGS. 1A-B. That is, in such examples, the user is in front of and facing toward the array 102 (as well as the display 236 to view the GUI). When in the selfie-mode, the preview images in first side image frame 406 and the second side image frame 408 are warped into a trapezoidal shape to provide a three-dimensional (3D) effect in which the outer lateral edges (e.g., larger distal edges relative to the center image) of the side image frames 406, 408 appear to be angled toward the user and/or object to be captured, as shown in FIG. 4, while the inner lateral edges (e.g., smaller proximate edges relative to the center image) of the side image frames 406, 408 appear to be farther away. This 3D effect is intended to mimic the angled shape of the image sensors 111 in the array 102 surrounding the user positioned within the region of interest 108 as shown in FIG. 1A.

The example perspective invert button 420 of the scene set-up graphics 400, 500 causes the user interface execution 204 to switch the GUI from the selfie mode (FIG. 4) to the director mode (FIG. 5). The term “director mode” is used herein to refer to a scenario in which the object 104 that is subject of focus for variable viewpoint media is distinct from the user. In director mode it is assumed that the user is facing the object 104 from behind the array 102 of image sensors 111. That is, in the director mode the user is assumed to be on the opposite side of the array 102 and facing in the opposite direction as compared with the selfie mode. Accordingly, in response to a user switching from the selfie mode (shown in FIG. 4) to the director mode (shown in FIG. 5), the example widget generation circuitry 218 swaps the positions of the first side image frame 406 and the second image frame 408, inverts the image(s) and/or video stream displayed in all three image frames 404, 406, 408, and warps the first side image frame 406 and the second image frame 408 (on opposite sides relative to the selfie mode) to provide a 3D effect in which the outer lateral edges of the side image frames 406, 408 are smaller than the inner lateral edges to make the image frames 406, 408 appear to be angled away from the user. This 3D effect is intended to mimic the angled shape of the image sensors 111 in the array 102 angled away from the user (assumed to be behind the array 102) and surrounding the object 104 within the region of interest 108.

The example scene set-up graphics 400, 500 illustrated in FIGS. 4 and 5 include an example pivot axis line 422 to represent a pivot axis of the scene, such as the pivot axis line 106 of FIG. 1. In some examples, the widget generation circuitry 218 superimposes the pivot axis line 422 on the center image frame 404, the first side image frame 406, and the second side image frame 408. Since the pivot axis line 422 is in the center of an example region of interest (ROI) (e.g., the ROI 104), the pivot axis line 422 is in the middle of the center image frame 404 (which, in this example, is assumed to be aligned with and/or centered on the region of interest 104 and, more particularly, the pivot axis line 422). In some examples, the pivot axis line 422 is superimposed on the first side image frame 406 and the second side image frame 408 to represent a distance of an axis of rotation for variable viewpoint media from the array 102, or the depth of the axis of rotation in the ROI. As shown in the illustrated examples, the pivot axis line 422 is not necessarily centered in the side images in the side image frames 406, 408 because the position of the pivot axis line 422 is defined with respect to the spatial relationship of the image sensors 111 to the surrounding environment associated with the ROI 104 as determined by the calibration of the image sensors 111.

The example scene set-up graphics 400, 500 illustrated in FIGS. 4 and 5 include an example cropped image indicator 424 in the center image frame 404 to indicate a portion of the full-frame image(s) captured by the image sensors that is cropped for use in generating variable viewpoint media (e.g., variable viewpoint media 234). Variable viewpoint media typically uses cropped portions of images corresponding to less than all of the full-image frames so that corresponding cropped portions of different images captured from different image sensors can be combined with the media focused on the object 104 of interest. Accordingly, in this example, the full-frame image of the central image sensor is shown in the center image frame 404 and the cropped image indicator 424 is superimposed to enable a user to visualize what portion of the full-image frame will be used in the variable viewpoint media. In the illustrated example, the cropped image indicator 424 corresponds to a bounded box. However, in other examples the cropped image indicator 424 can be any other suitable indicator of the portion of the full-frame image to be used for the variable viewpoint media. For instance, the cropped image indicator 424 can additionally or alternatively include a blurring or other change in appearance (e.g., conversion to grayscale) of the area outside of the cropped portion of the image. In some examples, as shown in FIGS. 4 and 5, the side image frames 406, 408 are limited to the cropped portions of the images associated with the selected image sensors 111. However, in other examples, the full-frame images of the side image sensors can also be presented along with a similar cropped image indicator 424.

The example first scene set-up graphic 400 illustrated in FIG. 4 includes an example first prompt 426 to instruct the user how to set-up the scene with the example GUI. The example first prompt 426 conveys to the user that the object to be capture (e.g., object 104, etc.) is to be aligned with the pivot axis line 422 in the center image frame 404. In some examples, the first prompt 426 includes words, phrases, and/or graphics different than respective ones illustrated in FIG. 4 to convey instructions of aligning the object with the pivot axis line 422.

The example second scene set-up graphic 500 illustrated in FIG. 5 includes a second prompt 502 to instruct the user how to further set-up the scene with the example GUI. The example second prompt 502 conveys that the object (e.g., object 104, etc.) is to be aligned with the pivot axis line 422 in the first frame 406 and the second frame 408. In some examples, the second prompt 502 includes words, phrases, and/or graphics different than respective ones illustrated in FIG. 5 to convey instructions of aligning the object with the pivot axis line 422. The example first and/or second prompts 426, 502 of FIGS. 4 and/or 5 include one or more buttons that cause the widget generation circuitry 218 to switch between the illustrated prompts and/or to generate a third prompt instructing the user on other ways to set-up the scene. The example first or second prompts 426, 502 can be presented in connection with either the selfie mode (FIG. 4) or the director mode (FIG. 5).

The example scene set-up graphics 400, 500 illustrated in FIGS. 4 and 5 include an example distance controller 428 to enable a user to adjust the distance of the pivot axis line 422 from the array 102 of image sensors 111. In some examples, as the distance of the pivot axis line 422 is adjusted by a user interacting with the distance controller 428, the media processing circuitry 214 adjusts the cropped areas in the first image frame 406 and the second image frame 408 to shift so that the cropped portion of the image represented in the side image frames 406, 408 shifts to align with the change in position of the pivot axis. Additionally or alternatively, in some examples, as the distance of the pivot axis line 422 is adjusted by a user, the line representing the pivot axis line 422 superimposed on the side image frames 406, 408 shifts position (e.g., either closer to or farther from the center image frame) based on how the distance controller 428 is changed by the user. The example cropped image(s) and/or video stream(s) are adjusted such that the pivot axis line 422 appears to move forward and/or backward in the ROI based on the user input to the distance controller 428. For example, if the user moves an example knob of the distance controller 428 toward the “Near” end, then the example media processing circuitry 214 moves the cropped portion of the image data from left to right in the first side image frame 406 (e.g., toward the center image frame 404). The locations of the example first side image frame 406 and associated pivot axis line do not move in the window 402, but the image sensor appears to move from left to right due to the adjustment. The user may adjust the example distance controller 428 until the object (e.g., the object 104, etc.) is aligned in depth with the pivot axis line 422.

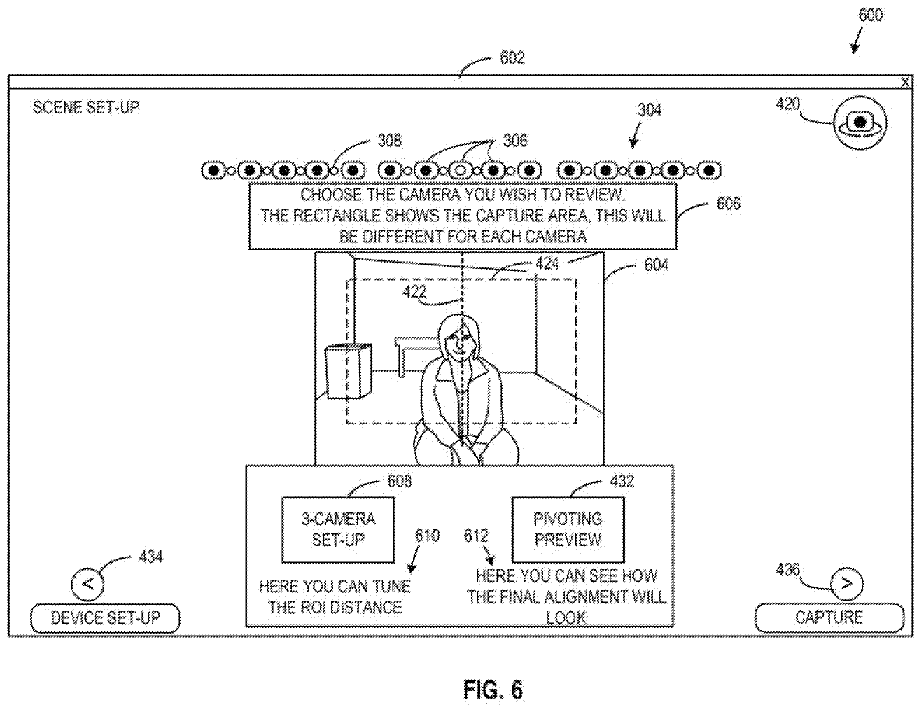

The example scene set-up graphics 400, 500 illustrated in FIGS. 4 and 5 include an example single perspective button 430 to cause the widget generation circuitry 218 to remove the pixel data for the first side image frame 406 and the second side image frame 408 and to generate pixel data of the selected image sensor in the center image frame 404. In some examples, the single perspective button 430 also causes the widget generation circuitry 218 to change the first prompt 426 to other prompt(s) and/or instruction(s) and to remove the distance controller 428 from the window 402. Further details regarding changes to the GUI that the single perspective button 430 causes are described below in reference to FIG. 6.

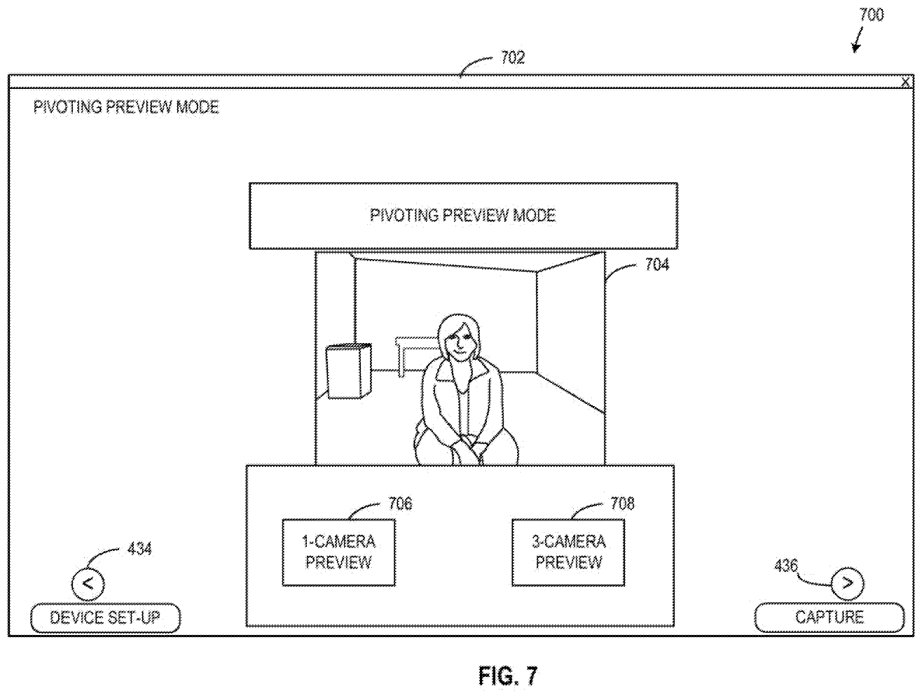

The example scene set-up graphics 400, 500 illustrated in FIGS. 4 and 5 include an example pivoting preview button 432 to cause the GUI to proceed to a subsequent graphic for generating a pivoting preview animation of variable viewpoint media, in response to user input(s). Further details regarding changes to the GUI that the pivoting preview button 432 causes are described below in reference to FIG. 7.

The example scene set-up graphics 400, 500 illustrated in FIGS. 4 and 5 include an example device set-up button 434 to cause the GUI to revert to the device set-up graphic 300 of FIG. 3, in response to user input(s). The user may then continue setting up the array 102 to properly capture image data for variable viewpoint media as described above.

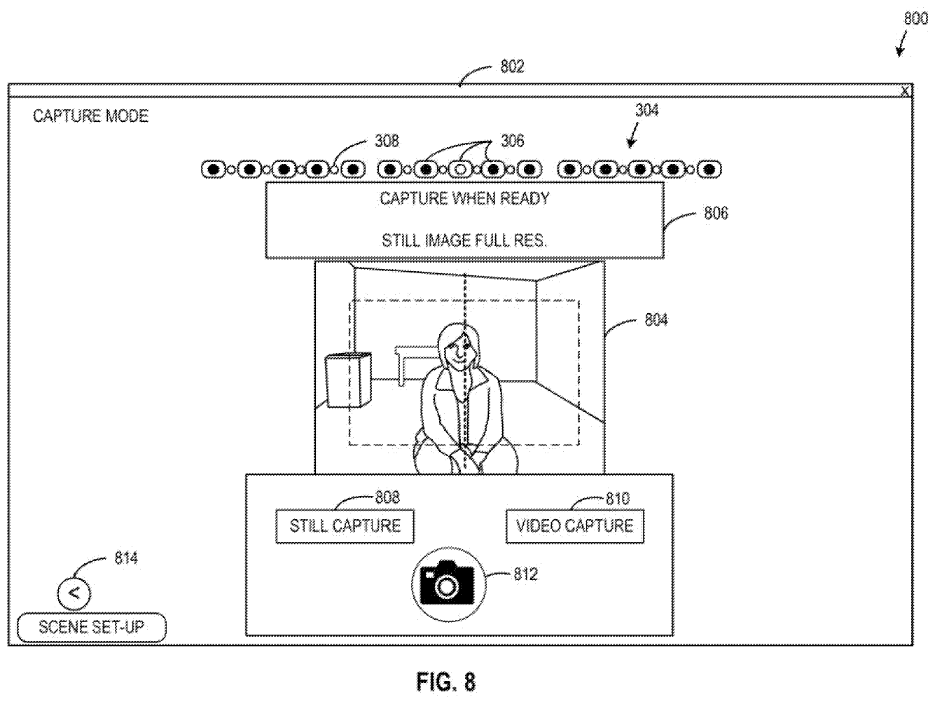

The example scene set-up graphics 400, 500 illustrated in FIGS. 4 and 5 includes an example capture mode button 436 to cause the GUI to proceed to a subsequent graphic to capture image data for variable viewpoint media, in response to user input(s). Further details regarding changes to the GUI that the capture mode button 436 causes are described below in reference to FIG. 8.

FIG. 6 is an example illustration of a single perspective graphic 600 of the GUI for generating variable viewpoint media. The example single perspective graphic 600 depicts one perspective of a selected image sensor in a scene set-up portion of the GUI. In some examples, the widget generation circuitry 218 generates and/or renders the graphic(s), window(s), and widgets of the single perspective graphic 600 in response to activation and/or selection of the single perspective button 430 shown in FIGS. 4 and 5.

The example single perspective graphic 600 includes an example single perspective window 602 and an example image frame 604 to provide a preview or video stream from a particular image sensor selected by the user. In some examples, the particular image to be previewed in the single perspective graphic 600 of FIG. 6 is based on user selection of one of the image sensor icons 306 of the panel 304 described above in connection with FIG. 3.

The example single perspective graphic 600 illustrated in FIG. 6 includes a third prompt 606 to instruct the user how to observe the viewpoints of the various image sensors 111 with the example GUI. The example third prompt 606 conveys to the user that the image sensor viewpoint to be inspected is selectable via perspective control panel 304 and that the cropped image indicator 424 represents portion(s) of the image frame 604 that are to be included in the final variable viewpoint media 234. In some examples, the third prompt 606 includes words, phrases, and/or graphics different than respective ones illustrated in FIG. 6 to convey instructions for inspecting viewpoints and cropped portions of the image(s) and/or video stream(s) that the array 102 captures.

The example single perspective graphic 600 illustrated in FIG. 6 includes a triple perspective button 608 to revert back to the first scene set-up graphic 400 or the second scene set-up graphic 500, in response to user input(s). The example single perspective graphic 600 illustrated in FIG. 6 includes a fourth prompt 610 associated with the triple perspective button 608 to inform the user that the location of the pivot axis and/or the ROI can be adjusted via the first scene set-up graphic 400 and/or the second scene set-up graphic 500. The example fourth prompt 624 conveys to the user that the triple perspective button 608 causes the GUI to revert to the first scene set-up graphic 400 and/or the second scene set-up graphic 500 to enable the user to align the object (e.g., object 104) with the pivot axis line 422. In some examples, the fourth prompt 610 includes words, phrases, and/or graphics different than respective ones illustrated in FIG. 6 to convey how to change the pivot axis line 422 location.

The example single perspective graphic 600 illustrated in FIG. 6 includes a fifth prompt 612 associated with the pivoting review button 432 to inform the user that a pivoting preview animation (e.g., pivoting preview animation(s) 232) can be generated in response to user selection of the pivoting preview button 432. The example fifth prompt 612 conveys to the user that the pivoting preview button 432 causes the GUI to proceed to graphic(s) that cause the computing device 110 to generate the pivoting preview animation, as described in greater detail below in reference to FIG. 7. In some examples, the fifth prompt 612 includes words, phrases, and/or graphics different than respective ones illustrated in FIG. 6 to convey how to preview variable viewpoint media. In some examples, the fifth prompt 612 is included in the first scene set-up graphic 400 and/or the second scene set-up graphic 500 in a same or similar location as illustrated in FIG. 6.

FIG. 7 is an example illustration of a pivoting preview graphic 700 of the GUI for generating the pivoting preview animation of variable viewpoint media. As shown in FIG. 7, the pivoting preview graphic 700 includes an example pivoting preview window 702 that contains an example image frame 704 within which a pivoting preview animation is displayed. In some examples, the pivoting preview graphic 700 automatically displays the pivoting preview animation that the media processing circuitry 214 generates. In some examples, the pivoting preview animation is a video showing sequential images captured by successive ones of the image sensors 111 in the array 102 captures. For instance, a first view in the preview animation corresponds to an image captured by the leftmost image sensor 111 in the array 102 and the next view in the preview corresponds to an image captured by the image sensor immediately to the right of the leftmost sensor 111. In such an example, each successive view in the preview corresponds to the next adjacent image sensor 111 moving to the right until reaching to rightmost image sensor 111 in the array 102. In other examples, the preview begins with the rightmost image sensor and move towards the leftmost image sensor.

The example images of the pivoting preview animation may be captured at a same or sufficiently similar time (e.g., within one second) as an activation and/or selection of the pivoting preview button(s) 432, 532, and/or 622 of FIGS. 4-6. In such examples, each view associated with each image sensor corresponds to a still image. Alternatively, in some examples, the preview animation may be based on a live video feed from each image sensor such that each view in the animation corresponds to a most recent point in time. Further, in some examples, each view may be maintained for a threshold period of time (corresponding to more than a single frame of the video stream) to allow more time for the user to review each view. However, in some examples, the threshold period of time is relatively short (e.g., 2 seconds, 1 second, less than 1 second) to give the effect of transition between views as would appear in final variable viewpoint media. In some examples, the pivoting preview animation has a looping timeline such that the pivoting preview animation restarts after reaching the end of the preview (e.g., after the view of each image sensor has been presented in the preview). In some examples, the pivoting preview animation has a bouncing timeline such that the preview alternates direction in response to reaching the end and/or beginning of the preview.

The example image frame 704 illustrated in FIG. 7 may depict the full-frame images of the pivoting preview animation, as opposed to the final cropped frames. In other examples, the pivoting preview animation depicts only the cropped portions of the full-frame images captured by the image sensors 111. In some examples, the images of the pivoting preview animation are lower resolution images to conserve processing time and resources of the computing device 110.

FIG. 8 is an example illustration of a capture graphic 800 of the GUI for generating variable viewpoint media. As shown in FIG. 8, the capture graphic 800 includes an example capture window 802 that contains an example image frame 804 within which an image to be captured is displayed. In some examples, the capture mode graphic 800 captures image(s) or video(s) for generating variable viewpoint media as described above. In some examples, the viewpoint interpolation circuitry 215 interpolates and combines the pixel data into a single data source in response to the capture. In other examples, the computing device 110 does not interpolate the captured images, instead the communication interface circuitry 208 uploads the captured pixel data to the server 238 for interpolation and generation of variable viewpoint media.

The example capture graphic 800 of FIG. 8 includes a sixth prompt 806 to instruct the user that the GUI is ready to capture the variable viewpoint media and/or how to capture the variable viewpoint image or video. The example sixth prompt 806 conveys that the still capture mode or the video capture mode is selected based on user input(s) to and/or a default selection of a still capture button 808 or a video capture button 810. In some examples, the sixth prompt 806 includes words, phrases, and/or graphics different than respective ones illustrated in FIG. 8 to convey how to capture image data for variable viewpoint media generation as well as what type of image data (e.g., still images or video) are to be captured.

The example capture graphic 800 of FIG. 8 includes the still capture button 808 to activate and/or facilitate the still capture mode of the capture graphic 800 in response to user input(s). In the still capture mode, the image sensors 111 are controlled to capture still images. More particularly, in some examples, the image sensors 111 are controlled so that the still images are captured synchronously. The example capture graphic 800 of FIG. 8 includes the video capture button 810 to activate and/or facilitate the video capture mode of the capture graphic 800 in response to user input(s). In the video capture mode, the image sensors 111 are controlled to capture video. In some such examples, the image sensors 111 are synchronized so that individual image frames of the videos captured by the different image sensors are temporally aligned. In some examples, the activation and/or selection of the video capture button 810 causes the widget generation circuitry 218 to alter pixel data of a capture button 812 such that the capture button 812 changes appearance from a camera graphic (shown in FIG. 8) to a red dot typical of other video recording implementations. In some examples, the selection of the video capture button 810 causes the widget generation circuitry 218 to alter the sixth prompt 806 to convey that the video capture mode is currently selected. For example, instead of reading, “Still image Full Res.”, the sixth prompt 806 may read, “Video image Full Res.”

The example capture graphic 800 of FIG. 8 includes the capture button 812 to capture image data and/or video data utilized to generate variable viewpoint media (e.g., a variable viewpoint image or a variable viewpoint video) in response to user input(s). In some examples, in response to a first input to the capture button 812, the function execution circuitry 222 sends a command to the image sensors to capture a frame of image data or multiple frames of image data based on a selection of the still capture button 808 and/or the video capture button 810. In some examples, if the video capture button 810 is selected, the function execution circuitry 222 sends a command to the image sensors to cease capturing the frames of image data based on a second selection of the capture button 812.

The example capture graphic 800 of FIG. 8 includes a scene set-up button 814 to cause the GUI to revert to the first scene set-up graphic 400 of FIG. 4 or the second scene set-up graphic 500 of FIG. 5 in response to user input(s). The example scene set-up button 814 performs a same and/or similar function in response to user input(s) as the example device set-up button(s) 434 of FIGS. 4-7.

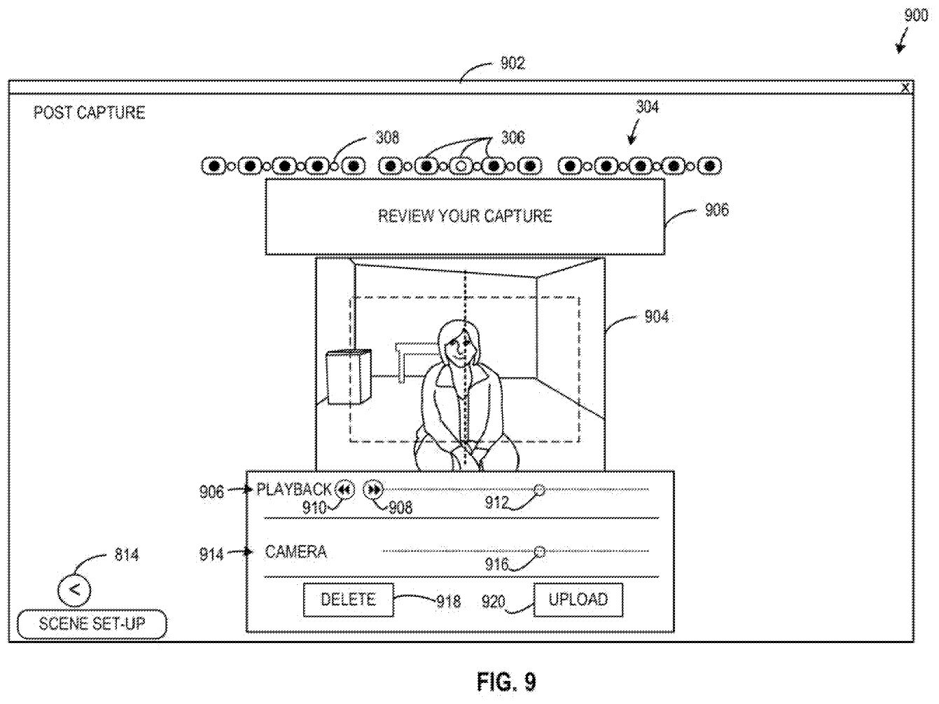

FIG. 9 is an example illustration of a post-capture graphic 900 of the GUI for reviewing the captured image(s) or video(s) utilized to generate variable viewpoint media. As shown in FIG. 9, the post-capture graphic 900 includes an example post-capture window 902 that contains an example image frame 904 within which a captured image(s) is displayed. In some examples, the post-capture graphic 900 allows the user to inspect, review, and/or watch the individual frames of image data from different perspectives associated with the different image sensors 111 in the array 102.

The example capture graphic 900 of FIG. 9 includes an example playback controller 906 to cause the widget generation circuitry 218 to display various frame(s) of the captured video in the image frame 904 in response to user input(s) to an example play/pause button 908, an example mute button 910, and/or an example playback slider 912. In some examples, the play/pause button 908 can cause the captured video to play from a selected point in a timeline of the video. In some examples, the location of the playback slider 912 indicates the point in the timeline at which playback occurs. In some examples, the mute button 910 causes the communication interface circuitry 208 to cease outputting audio signals of the video from an audio output device (e.g., a speaker, headphone(s), etc.). In some examples, if the still capture mode was selected in the capture graphic 800, the playback controller 906 and the associated visual indicators and/or controls are omitted.

The example capture graphic 900 of FIG. 9 includes an example viewpoint controller 914 to cause the widget generation circuitry 218 to display different image sensor perspectives of the array 102 in the image frame 904 in response to user input(s) to an example viewpoint slider 916. In some examples, the viewpoint controller 914 includes the viewpoint slider 916 and/or another controller interface, such as a numerical input, a rotating knob, a series of buttons, etc. The example viewpoint controller 914 can cause display of various perspectives during playback of the captured video.

The example capture graphic 900 of FIG. 9 includes an example delete button 918 to cause the computing device 110 to permanently and/or temporarily delete the captured image(s) and/or video(s) from the storage device(s) 206. In some examples, the function execution circuitry 222 notifies the storage device(s) 206 and/or other circuitry on the computing device 110 to delete the captured image(s) and/or video(s) in response to user input(s) to the delete button 918.

The example capture graphic 900 of FIG. 9 includes an example upload button 920 to cause the computing device 110 to transmit the captured image(s) and/or video(s) to the server 238 via the network 202 in response to user input(s). In some examples, the user can cause the server 238 to generate variable viewpoint media (e.g., variable viewpoint media 234) using interpolation methods described above. In some examples, the user can cause the computing device 110 to generate variable viewpoint media (e.g., via the viewpoint interpolation circuitry 215) and send the variable viewpoint media (e.g., variable viewpoint media 234) to the sever 236 for further editing, processing, or manipulation.

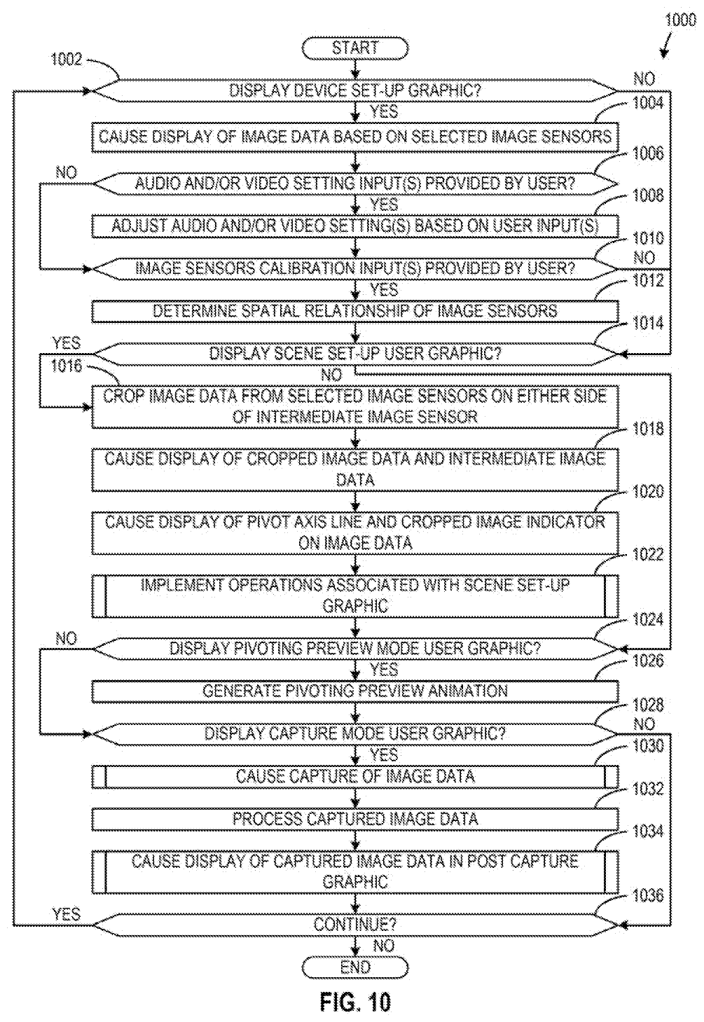

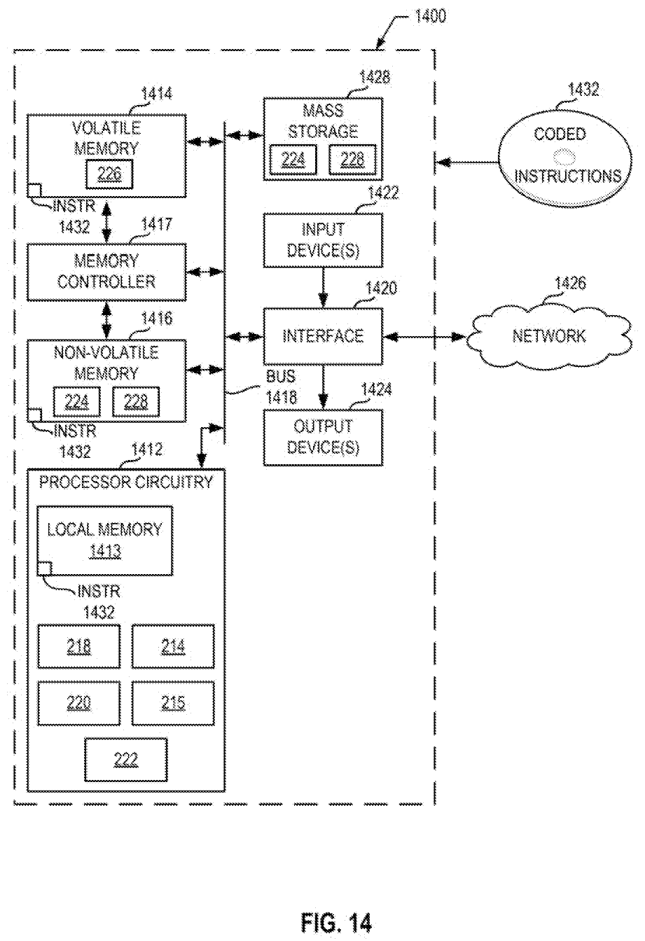

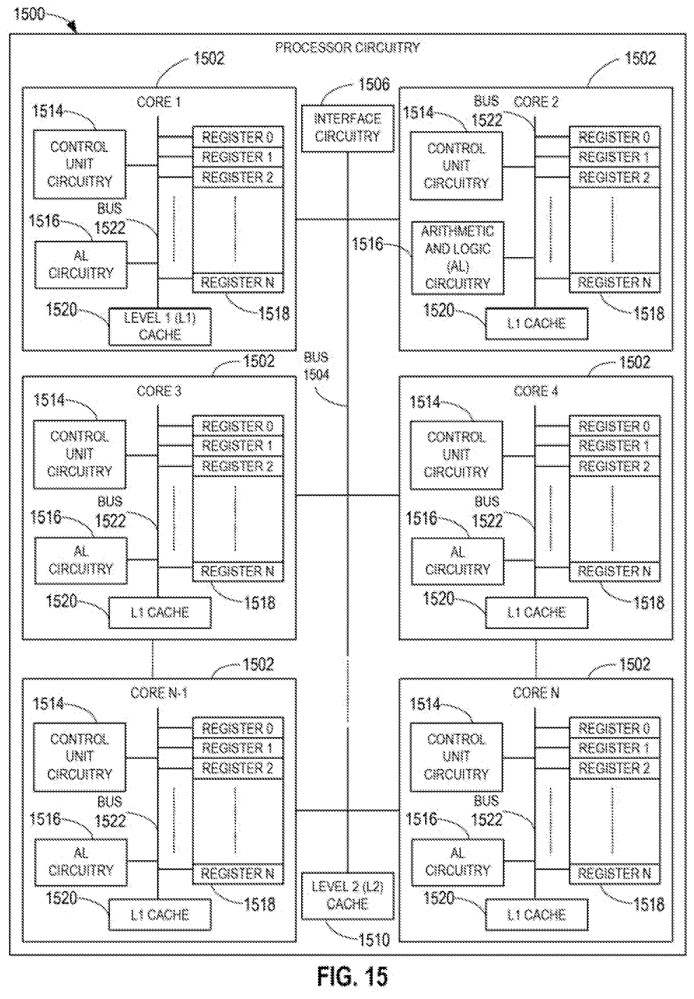

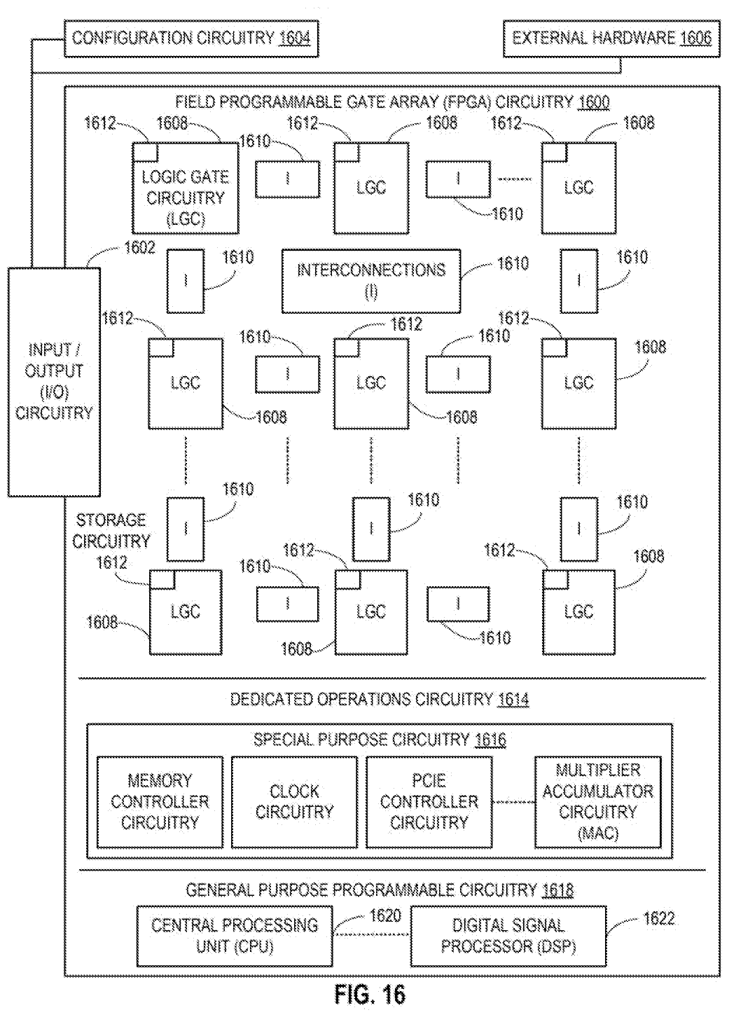

In some examples, the computing device 110 includes means for adjusting audio and/or video setting(s) for microphone(s) and/or image sensor(s) 111 of the multi-camera array 102. For example, the means for adjusting setting(s) may be implemented by the audio visual calibration circuitry 210. In some examples, the audio visual calibration circuitry 210 may be instantiated by processor circuitry such as the example processor circuitry 1412 of FIG. 14. For instance, the audio visual calibration circuitry 210 may be instantiated by the example general purpose processor circuitry 1500 of FIG. 15 executing machine executable instructions such as that implemented by at least blocks 1008 of FIG. 10. In some examples, audio visual calibration circuitry 210 may be instantiated by hardware logic circuitry, which may be implemented by an ASIC or the FPGA circuitry 1600 of FIG. 16 structured to perform operations corresponding to the machine readable instructions. Additionally or alternatively, the audio visual calibration circuitry 210 may be instantiated by any other combination of hardware, software, and/or firmware. For example, the audio visual calibration circuitry 210 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the computing device 110 includes means for determining a spatial relationship of the image sensor(s) 111 of the multi-camera array 102. For example, the means for determining the spatial relationship may be implemented by the image sensor calibration circuitry 212. In some examples, the image sensor calibration circuitry 212 may be instantiated by processor circuitry such as the example processor circuitry 1412 of FIG. 14. For instance, the image sensor calibration circuitry 212 may be instantiated by the example general purpose processor circuitry 1500 of FIG. 15 executing machine executable instructions such as that implemented by at least blocks 1012 of FIG. 10. In some examples, image sensor calibration circuitry 212 may be instantiated by hardware logic circuitry, which may be implemented by an ASIC or the FPGA circuitry 1600 of FIG. 16 structured to perform operations corresponding to the machine readable instructions. Additionally or alternatively, the image sensor calibration circuitry 212 may be instantiated by any other combination of hardware, software, and/or firmware. For example, the image sensor calibration circuitry 212 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

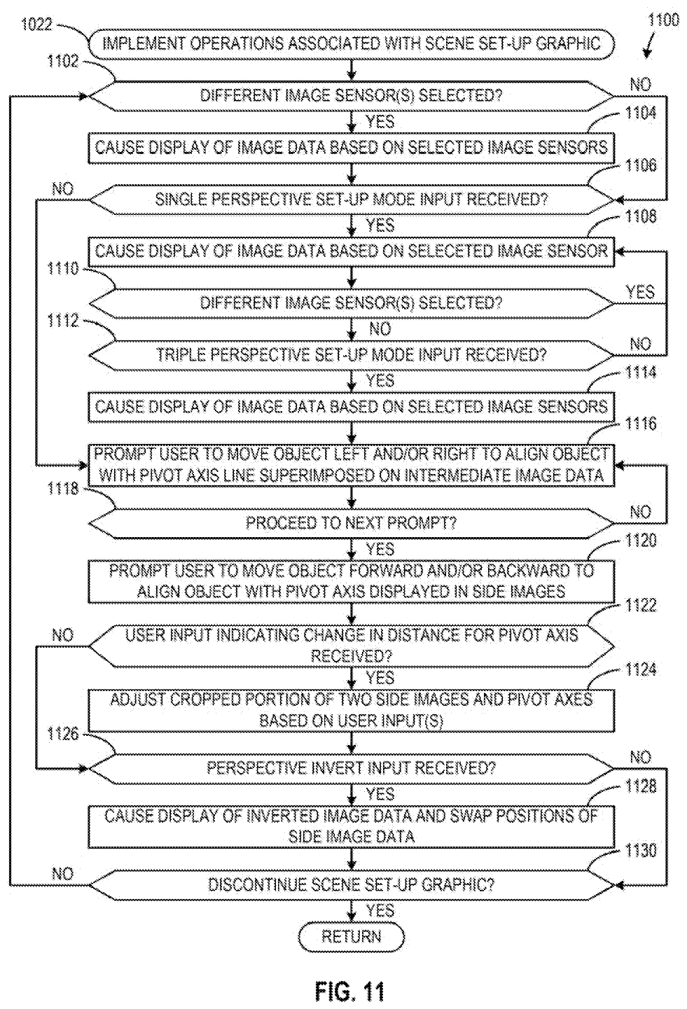

In some examples, the computing device 110 includes means for processing media (e.g., image(s), video(s), etc.) to be captured by the image sensors 111 of the multi-camera array 102. For example, the means for processing may be implemented by the media processing circuitry 214. In some examples, the media processing circuitry 214 may be instantiated by processor circuitry such as the example processor circuitry 1412 of FIG. 14. For instance, the media processing circuitry 214 may be instantiated by the example general purpose processor circuitry 1500 of FIG. 15 executing machine executable instructions such as that implemented by at least blocks 1016 and 1026 of FIGS. 10 and 1124 of FIG. 11. In some examples, media processing circuitry 214 may be instantiated by hardware logic circuitry, which may be implemented by an ASIC or the FPGA circuitry 1600 of FIG. 16 structured to perform operations corresponding to the machine readable instructions. Additionally or alternatively, the media processing circuitry 214 may be instantiated by any other combination of hardware, software, and/or firmware. For example, the media processing circuitry 214 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the computing device 110 includes means for interpolating intermediate images based on image data and/or video data captured by different ones of the image sensors 111. For example, the means for interpolating may be implemented by the viewpoint interpolation circuitry 215. In some examples, the viewpoint interpolation circuitry 215 may be instantiated by processor circuitry such as the example processor circuitry 1032 of FIG. 10. For instance, the viewpoint interpolation circuitry 215 may be instantiated by the example general purpose processor circuitry 1500 of FIG. 15 executing machine executable instructions such as that implemented by at least block 1012 of FIG. 10. In some examples, viewpoint interpolation circuitry 215 may be instantiated by hardware logic circuitry, which may be implemented by an ASIC or the FPGA circuitry 1600 of FIG. 16 structured to perform operations corresponding to the machine readable instructions. Additionally or alternatively, the viewpoint interpolation circuitry 215 may be instantiated by any other combination of hardware, software, and/or firmware. For example, the viewpoint interpolation circuitry 215 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

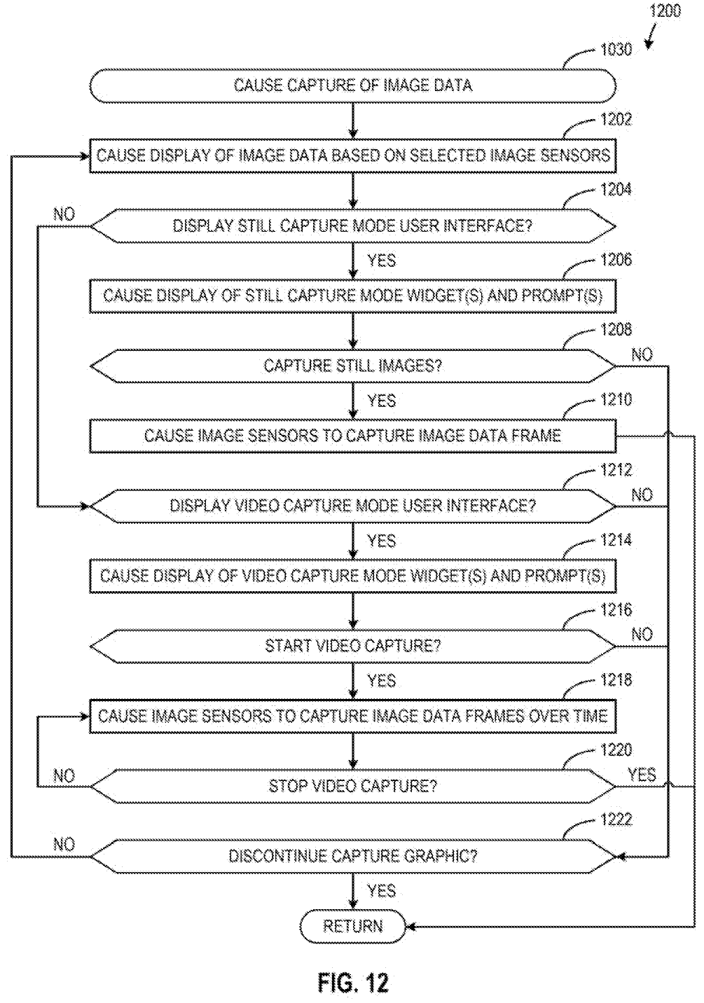

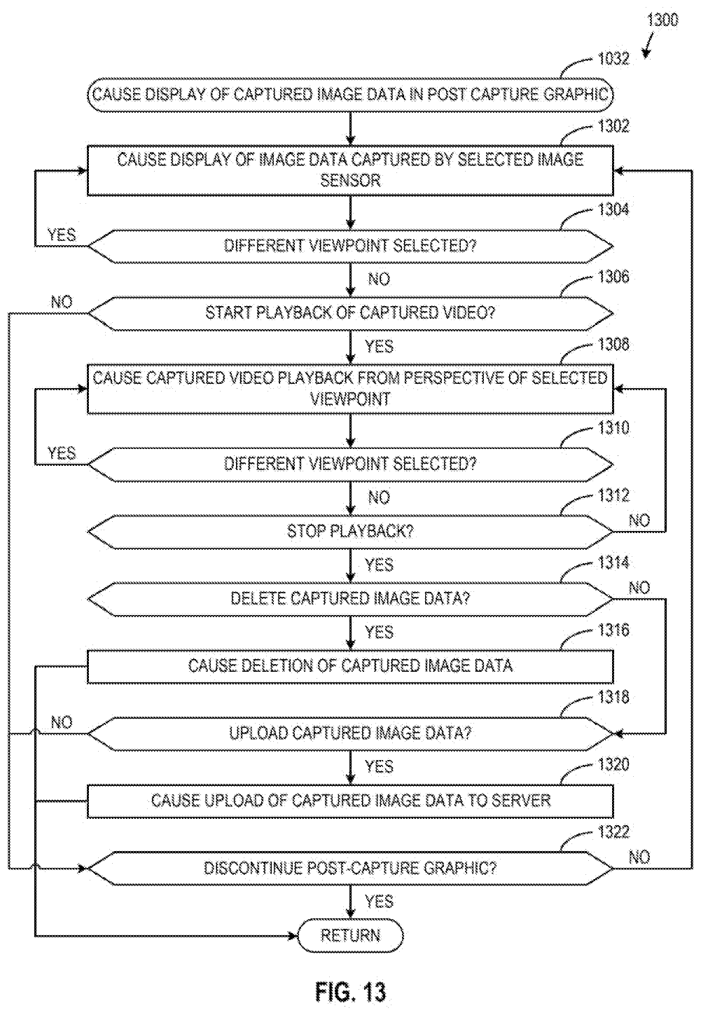

In some examples, the computing device 110 includes means for generating pixel data for graphic(s), window(s), and/or widget(s) of a graphical user interface for capturing variable viewpoint media. For example, the means for generating may be implemented by the widget generation circuitry 218. In some examples, the widget generation circuitry 218 may be instantiated by processor circuitry such as the example processor circuitry 1412 of FIG. 14. For instance, the widget generation circuitry 218 may be instantiated by the example general purpose processor circuitry 1500 of FIG. 15 executing machine executable instructions such as that implemented by at least blocks 1004, 1018, and 1020 of FIGS. 10, 1104, 1108, 1114, and 1128 of FIGS. 11, 1202, 1206, and 1214 of FIGS. 12, and 1302 and 1308 of FIG. 13. In some examples, widget generation circuitry 218 may be instantiated by hardware logic circuitry, which may be implemented by an ASIC or the FPGA circuitry 1600 of FIG. 16 structured to perform operations corresponding to the machine readable instructions. Additionally or alternatively, the widget generation circuitry 218 may be instantiated by any other combination of hardware, software, and/or firmware. For example, the widget generation circuitry 218 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the computing device 110 includes means for detecting user events based on user inputs to the graphical user interface for capturing the variable viewpoint media. For example, the means for generating may be implemented by the user event identification circuitry 220. In some examples, the user event identification circuitry 220 may be instantiated by processor circuitry such as the example processor circuitry 1412 of FIG. 14. For instance, the user event identification circuitry 220 may be instantiated by the example general purpose processor circuitry 1500 of FIG. 15 executing machine executable instructions such as that implemented by at least blocks 1002, 1006, 1010, 1014, 1024, 1028, and 1036 of FIG. 10, blocks 1102, 1106, 1110, 1112, 1118, 1122, 1126, and 1130 of FIG. 11, blocks 1204, 1208, 1212, 1216, 1220, and 1222 of FIG. 12, and blocks 1304, 1306, 1310, 1312, 1314, 1318, and 1322 of FIG. 13. In some examples, user event identification circuitry 220 may be instantiated by hardware logic circuitry, which may be implemented by an ASIC or the FPGA circuitry 1600 of FIG. 16 structured to perform operations corresponding to the machine readable instructions. Additionally or alternatively, the user event identification circuitry 220 may be instantiated by any other combination of hardware, software, and/or firmware. For example, the user event identification circuitry 220 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the computing device 110 includes means for executing functions of a variable viewpoint capture application 230 based on user events in the graphical user interface for capturing the variable viewpoint media. For example, the means for executing may be implemented by the function execution circuitry 222. In some examples, the function execution circuitry 222 may be instantiated by processor circuitry such as the example processor circuitry 1412 of FIG. 14. For instance, the function execution circuitry 222 may be instantiated by the example general purpose processor circuitry 1500 of FIG. 15 executing machine executable instructions such as that implemented by at least blocks 1022, 1030, and 1034 of FIG. 10, blocks 1116 and 1120 of FIG. 11, blocks 1210 and 1218 of FIG. 12, and blocks 1316 and 1320 of FIG. 13. In some examples, function execution circuitry 222 may be instantiated by hardware logic circuitry, which may be implemented by an ASIC or the FPGA circuitry 1600 of FIG. 16 structured to perform operations corresponding to the machine readable instructions. Additionally or alternatively, the function execution circuitry 222 may be instantiated by any other combination of hardware, software, and/or firmware. For example, the function execution circuitry 222 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier ( op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the computing device 110 of FIGS. 1A and 1B is illustrated in FIG. 2, one or more of the elements, processes, and/or devices illustrated in FIG. 2 may be combined, divided, re-arranged, omitted, eliminated, and/or implemented in any other way. Further, the example user interface execution circuitry 204, the example communication interface circuitry 208, the example audio visual calibration circuitry 210, the example image sensor calibration circuitry 212, the example media processing circuitry 214, the example viewpoint interpolation circuitry 215, and/or, more generally, the example computing device 110 of FIG. 2, may be implemented by hardware alone or by hardware in combination with software and/or firmware. Thus, for example, any of the example user interface execution circuitry 204, the example communication interface circuitry 208, the example audio visual calibration circuitry 210, the example image sensor calibration circuitry 212, the example media processing circuitry 214, the example viewpoint interpolation circuitry 215, and/or, more generally, the example computing device 110, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example computing device 110 of FIG. 2 may include one or more elements, processes, and/or devices in addition to, or instead of, those illustrated in FIG. 2, and/or may include more than one of any or all of the illustrated elements, processes and devices.

A flowchart representative of example hardware logic circuitry, machine readable instructions, hardware implemented state machines, and/or any combination thereof for implementing the computing device 110 of FIG. 2 is shown in FIGS. 10-13. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 15 and/or 16. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 10-13, many other methods of implementing the example computing device 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 10-13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 10 is a flowchart representative of example machine readable instructions and/or example operations 1000 that may be executed and/or instantiated by processor circuitry to cause the computing device 110 to facilitate a user in setting up scene(s) and enabling the capture image data containing an object in the scene. The machine readable instructions and/or the operations 1000 of FIG. 10 begin at block 1002, at which the user interface execution circuitry 204 determines if the device set-up graphic 300 is to be loaded and displayed. For example, the user event identification circuitry 220 can parse incoming user events from the communication interface circuitry 208 and detect a selection and/or activation of a GUI icon on the computing device 110 and/or the device set-up button 434 of FIGS. 4-7. If the user event identification circuitry 220 determines that the device set-up graphic 300 is not to be loaded and displayed, the example instructions and/or operations 1000 proceed to block 1014.

If the widget generation circuitry 208 determines (at block 1002) that the device set-up graphic 300 is to be loaded and displayed, then control advances to block 1004 where the user interface execution circuitry 204 causes captured image data (e.g., image(s), video stream(s), etc.) to be displayed via the display 236 based on the image sensor selected via the perspective control panel 304 of FIG. 3.

At block 1006, the user interface execution circuitry 204 determines whether audio and/or video setting input(s) have been provided by the user. For example, the user event identification circuitry 220 can parse incoming user events from the communication interface circuitry 208 and detect a selection, activation, and/or adjustment of the audio gain adjustment slider 310, the auto exposure slider 312, and/or the auto white balance slider 314 of FIG. 3. If the user event identification circuitry 220 determines that a user has not provided any audio and/or video setting inputs, the example instructions and/or operations 1000 proceed to block 1010.

If audio and/or video setting inputs were provided, control advances to block 1008 where the audio visual calibration circuitry 210 adjusts the audio and/or video setting(s) based on the user input(s).

At block 1010, the user interface execution circuitry 204 determines whether image sensor calibration input(s) have been provided by the user. For example, the user event identification circuitry 220 can parse incoming user events from the communication interface circuitry 208 and detect a selection, activation, and/or adjustment of the dynamic calibration button 316 of FIG. 3. If the user event identification circuitry 220 determines that the image sensor(s) are not to be calibrated, the example instructions and/or operations 1000 proceed to block 1014.

If image setting inputs were provided, control advances to block 1012 where the image sensor calibration circuitry 212 adjusts video setting(s) of the image sensor(s) of the multi-camera array 102 and/or the computing device 110.

At block 1014, the user interface execution circuitry 204 (e.g., via the user event identification circuitry 220) determines if a scene set-up graphic (e.g., the first scene set-up graphic 400 and/or the second scene set-up graphic 500) is to be loaded and displayed. If not, the example instructions and/or operations 1000 proceed to block 1024. If the scene set-up graphic is to be displayed, control advances to block 1016 where the media processing circuitry 214 crops image data from selected image sensors on either side of an intermediate (e.g., central) image sensor. In some examples, the selected image sensors are determined based on user selected image sensor icons 306 on either side of an intermediate (e.g., central) image sensor represented in the perspective control panel 304 of FIGS. 4 and/or 5.

At block 1018, the user interface execution circuitry 204 (e.g., via the widget generation circuitry 208) causes the cropped image data and the intermediate image data to be displayed. In some examples, the initial or default mode for the display of the image data is the selfie mode corresponding to the first scene set-up graphic 400 of FIG. 4. However, in other examples, the initial or default mode for the display of the image data is the director mode corresponding to the second scene set-up graphic 500 of FIG. 5.

At block 1020, the user interface execution circuitry 204 (e.g., via the widget generation circuitry 218) causes a pivot axis line (e.g., the pivot axis line 422) and a cropped image indicator (e.g., the cropped image indicator 424) to be displayed on the image data. In some examples, the position of the pivot axis lines is based on an initial position assumed for the pivot axis within the region of interest (ROI) of the scene to be imaged. However, this position can be adjusted by the user as discussed further below.

At block 1022, the user interface execution circuitry 204 (e.g., via the function execution circuitry 222) implements operations associated with the scene set-up graphic. An example implementation of block 1022 is provided further below in connection with FIG. 11.

At block 1024, the user interface execution circuitry 204 (e.g., via the user event identification circuitry 220) determines if the pivoting preview graphic 700 is to be loaded and displayed. If not, the example instructions and/or operations 1000 proceed to block 1028. If the pivoting preview graphic 700 is to be displayed, control advances to block 1026 where the video processing circuitry 214 generates the pivoting preview animation.

At block 1028, the user interface execution circuitry 204 (e.g., via the user event identification circuitry 220) determines if the capture graphic 800 is to be loaded and displayed. If not, the example instructions and/or operations 1000 proceed to block 1036.

If the capture graphic 800 is to be displayed, control advances to block 1030 where the user interface execution circuitry 204 (e.g., via the function execution circuitry 222) causes the capture of image data. An example implementation of block 1030 is provided further below in connection with FIG. 12.

At block 1032, the media processing circuitry 214 processes the captured image data. For example, the media processing circuitry 214 performs image segmentation, image enhancement, noise reduction, etc. based on configuration(s) of the computing device 110 and/or the variable viewpoint capture application 230. The processed image data output of the media processing circuitry 214 can be viewed from different perspectives of the array 102 during playback and/or viewing.

At block 1034, the user interface execution circuitry 204 (e.g., via the function execution circuitry 222) causes display of captured image data in a post-capture graphic (e.g., the post capture graphic 900). An example implementation of block 1034 is provided further below in connection with FIG. 13.

At block 1036, the user interface execution circuitry 204 (e.g., via the user event identification circuitry 220) determines whether to continue. If so, control returns to block 1002. Otherwise, the example instructions and/or operations 1000 end.

FIG. 11 is a flowchart representative of example machine readable instructions and/or example operations 1100 that may be executed and/or instantiated by processor circuitry to implement block 1022 of FIG. 10. The machine readable instructions and/or the operations 1100 of FIG. 11 begin at block 1102, at which the user interface execution circuitry 204 determines whether different image sensor(s) have been selected. For example, the user event identification circuitry 220 can parse incoming user events from the communication interface circuitry 208 and detect a selection and/or activation of an image sensor icon(s) of the perspective control panel 410 of FIG. 4 and/or the perspective control panel 510 of FIG. 5. If the user event identification circuitry 220 determines that different image sensor(s) have not been selected, the example instructions and/or operations 1100 proceed to block 1106.

If the user event identification circuitry 220 determines that different image sensor(s) have been selected, then control proceeds to block 1104 where the user interface execution circuitry 204 (e.g., via the widget generation circuitry 218) causes the image data (e.g., image(s), video stream(s), etc.) that the image sensors of the multi-camera array 102 capture to be displayed on the GUI.

At block 1106, the user interface execution circuitry 204 (e.g., via the user event identification circuitry 220) determines whether the single perspective set-up mode of the GUI has been selected. If the user event identification circuitry 220 determines that the single perspective set-up mode of the GUI has not been selected, then control proceeds to block 1116.

If the user event identification circuitry 220 determines that the single perspective set-up mode of the GUI has been selected, then control proceeds to block 1108 where the user interface execution circuitry 204 (e.g., via the widget generation circuitry 218) causes the image data (e.g., image(s), video stream(s), etc.) that the image sensor of the multi-camera array 102 captures to be displayed on the GUI.

At block 1110, the user interface execution circuitry 204 (e.g., via the user event identification circuitry 220) determines whether a different image sensor has been selected. If the user event identification circuitry 220 determines that a different image sensor has been selected, then control returns to block 1108.

At block 1112, the user interface execution circuitry 204 (e.g., via the user event identification circuitry 220) determines whether the triple perspective set-up mode of the GUI has been selected. If the user event identification circuitry 220 determines that the triple perspective set-up mode of the GUI has not been selected, then control returns to block 1108.

At block 1114, if the user event identification circuitry 220 determines that the triple perspective set-up mode of the GUI has been selected, then the user interface execution circuitry 204 (e.g., via the widget generation circuitry 218) causes the raw, preprocessed, and/or cropped image data (e.g., image(s), video stream(s), etc.) that the image sensors of the multi-camera array 102 capture to be displayed on the GUI.

At block 1116, the user interface execution circuitry 204 (e.g., via the widget generation circuitry 218) causes the GUI to prompt the user to move the object 104 left and/or right in the scene to align the object with the pivot axis line 422, 522 superimposed on the intermediate image data.

At block 1118, the user interface execution circuitry 204 determines whether to proceed to a next prompt. In some examples, this determination is made based on user input indicating the user is satisfied with the alignment of the object with the pivot axis line 422. If the user event identification circuitry 220 determines not to proceed, then control returns to block 1116.

At block 1120, if the user event identification circuitry 220 determines that progression of the first prompt 426 to the second prompt 526 has been selected, then the user interface execution circuitry 204 (e.g., via the widget generation circuitry 218) causes the GUI to prompt the user to move the object 104 forward and/or backward in the scene to align the object with the pivot axis line 422, 522 superimposed on the side image data frames.

At block 1122, the user interface execution circuitry 204 (e.g., via the user event identification circuitry 220) determines whether a location of the pivot axis line 422 of FIG. 4 or the pivot axis line 522 of FIG. 5 has been changed. If the user event identification circuitry 220 determines that the location of the pivot axis line 422 of FIG. 4 or the pivot axis line 522 of FIG. 5 has not been changed, then control proceeds to block 1126.

At block 1124, if the user event identification circuitry 220 determines that the location of the pivot axis line 422 of FIG. 4 or the pivot axis line 522 of FIG. 5 has been changed, then the media processing circuitry 214 moves the pivot axis line 422, 522 forward and/or backward in the scene based on user input(s) to the distance slider 428, 528.

At block 1126, the user interface execution circuitry 204 (e.g., via the user event identification circuitry 220) whether perspectives of the center image frame 404, 504, the first side image frame 406, 506, and/or the second side image frame 408, 508 are to be swapped and/or inverted. If the user event identification circuitry 220 determines that the perspectives of the center image frame 404, 504, the first side image frame 406, 506, and/or the second side image frame 408, 508 are not to be swapped and/or inverted, the example instructions and/or operations 1100 proceed to block 1130.

At block 1128, if the u user event identification circuitry 220 determines that perspectives of the center image frame 404, 504, the first side image frame 406, 506, and/or the second side image frame 408, 508 are to be swapped and/or inverted, then the user interface execution circuitry 204 (e.g., via the widget generation circuitry 208) causes the image data (e.g., image(s), video stream(s), etc.) that the array 102 captures to be inverted and the positions of the side image data to be swapped.

At block 1130, the user interface execution circuitry 204 (e.g., via the user event identification circuitry 220) determines if the scene set-up mode of the GUI is to be discontinued. If the user event identification circuitry 220 determines that the scene set-up mode of the GUI is not to be discontinued, then the example instructions and/or operations 1100 return to block 1102. If the user event identification circuitry 220 determines that the scene set-up mode of the GUI is to be discontinued, the example instructions and/or operations 1100 return to block 1024 of FIG. 10.

FIG. 12 is a flowchart representative of example machine readable instructions and/or example operations 1200 that may be executed and/or instantiated by processor circuitry to implement block 1030 of FIG. 10. The machine readable instructions and/or the operations 1200 of FIG. 12 begin at block 1202, at which the user interface execution circuitry 204 (e.g., via the widget generation circuitry 218) causes the image data (e.g., image(s), video stream(s), etc.) that the array 102 captures to be displayed on the GUI.

At block 1204, the user interface execution circuitry 204 (e.g., via the user event identification circuitry 220) determines if the still capture mode of the capture graphic 800 has been selected. If the user event identification circuitry 220 determines that the still capture mode of the capture graphic 800 has not been selected, the example instructions and/or operations 1200 proceed to block 1212.

At block 1206, if the user event identification circuitry 220 determines that the still capture mode of the capture graphic 800 has been selected, then the user interface execution circuitry 204 (e.g., via the widget generation circuitry 218) causes the widget(s) and/or prompt(s) of the still capture mode of the capture graphic 800 to be displayed on the GUI.

At block 1208, the user interface execution circuitry 204 (e.g., via the user event identification circuitry 220) determines if a still capture of image data has been selected. If the user event identification circuitry 220 determines that still capture of image data has not been selected , the example instructions and/or operations 1200 proceed to block 1222.

If the user event identification circuitry 220 determines that the still capture of image data has been selected, then control proceeds to block 1210 where user interface execution circuitry 204 (e.g., via the function execution circuitry 222) causes the image sensors of the multi-camera array 102 to capture one or more frame(s) of image data for the variable viewpoint image.

At block 1212, the user interface execution circuitry 204 (e.g., via the user event identification circuitry 220) determines if a video capture mode of the capture graphic 800 has been selected. If the user event identification circuitry 220 determines that video capture mode of the capture graphic 800 has not been selected, the example instructions and/or operations 1200 proceed to block 1222.

If the user event identification circuitry 220 determines that the video capture mode of the capture graphic 800 has been selected, then control proceeds to block 1214 where the user interface execution circuitry 204 (e.g., via the widget generation circuitry 218) causes the widget(s) and/or prompt(s) of the video capture mode of the capture graphic 800 to be displayed on the GUI.

At block 1216, the user interface execution circuitry 204 (e.g. via the user event identification circuitry 220) determines whether a commencement of video capture of image data has been selected. If the user event identification circuitry 220 determines that the commencement video capture of image data has not been selected, then the example instructions and/or operations 1200 proceed to block 1222.

If the user event identification circuitry 220 determines that the commencement video capture of image data has been selected, then control proceeds to block 1218 where the user interface execution circuitry 204 (e.g., via the function execution circuitry 222) causes the image sensors of the multi-camera array 102 to capture frames of image data for the variable viewpoint video.

At block 1220, the user interface execution circuitry 204 (e.g., via the user event identification circuitry 220) determines whether a cessation of the video capture of the image data has been selected. If the user event identification circuitry 220 determines that cessation of the video capture of the image data has not been selected, then the example instructions and/or operations 1200 return to block 1218.

At block 1222, the user interface execution circuitry 204 (e.g., via the user event identification circuitry 220) determines whether the capture mode the GUI has been discontinued. If the user event identification circuitry 220 determines that the capture mode the GUI has not been discontinued, then the example instructions and/or operations 1200 return to block 1202. If the user event identification circuitry 220 determines that the capture mode the GUI has been discontinued, then the example instructions and/or operations 1200 return to block 1032 of FIG. 10.

FIG. 13 is a flowchart representative of example machine readable instructions and/or example operations 1300 that may be executed and/or instantiated by processor circuitry to implement block 1034 of FIG. 10. The machine readable instructions and/or the operations 1300 of FIG. 13 begin at block 1302, at which the user interface execution circuitry 204 (e.g., via the widget generation circuitry 218) causes the image data (e.g., image, video frame, etc.) that the selected image sensor of the array 102 captured to be displayed on the GUI.

At block 1304, the user interface execution circuitry 204 (e.g., via the user event identification circuitry 220) determines whether a different viewpoint has been selected. If the user event identification circuitry 220 determines that a different viewpoint has been selected, the example instructions and/or operations 1300 return to block 1302.

If the user event identification circuitry 220 determines that a different viewpoint has not been selected, then control proceeds to block 1306 where the user interface execution circuitry 204 (e.g., via the user event identification circuitry 220) determines if playback of the captured video has begun. If the user event identification circuitry 220 determines that playback of the captured video has not begun, the example instructions and/or operations 1300 proceed to block 1322.

If the user event identification circuitry 220 determines that playback of the captured video has begun, then control proceeds to block 1308 where the user interface execution circuitry 204 (e.g., via the widget generation circuitry 218) causes the variable viewpoint video to begin the playback of the variable viewpoint video from the perspective of the viewpoint selected via the viewpoint controller 914 of FIG. 9.

At block 1310, the user interface execution circuitry 204 (e.g., via the user event identification circuitry 220) determines if a different viewpoint has been selected during the playback of the captured video. If the user event identification circuitry 220 determines that a different viewpoint has been selected during the playback of the captured video, the example instructions and/or operations 1300 return to block 1308.

If the user event identification circuitry 220 determines that a different viewpoint has not been selected during the playback of the captured video, then control proceeds to block 1312 where the user interface execution circuitry 204 (e.g., via the user event identification circuitry 220) determines whether a cessation of the playback of the captured video has been selected. If the user event identification circuitry 220 determines that the cessation of the playback of the captured video has not been selected, then the example instructions and/or operations 1300 return to block 1308.

If the user event identification circuitry 220 determines that the cessation of the playback of the captured video has been selected, then control proceeds to block 1314 where the user interface execution circuitry 204 (e.g., via the user event identification circuitry 220) determines whether a deletion of the captured image data has been selected. If the user event identification circuitry 220 determines that the deletion of the captured image data has not been selected, then the example instructions and/or operations 1300 proceed to block 1318.

If the user event identification circuitry 220 determines that the deletion of the captured image data has been selected, then control proceeds to block 1316 where the user interface execution circuitry 204 (e.g., via the function execution circuitry 222) deletes the variable viewpoint media from the computing device 110 and/or external storage device. In response to deleting the image data, the example instructions and/or operations 1300 return to block 1036 of FIG. 10.

At block 1318, the user interface execution circuitry 204 (e.g., via the user event identification circuitry 220) determines if an upload of the captured image data has been selected. If the user event identification circuitry 220 determines that the upload of the captured image data has not been selected, then the example instructions and/or operations 1300 proceed to block 1322.

If the user event identification circuitry 220 determines that the upload of the captured image data has been selected, then control proceeds to block 1320 where the communication interface circuitry 208 uploads the captured image data from the computing device 110 to the server 236. In response to uploading the captured image data, the example instructions and/or operations 1300 return to block 1036 of FIG. 10.

At block 1322, the user interface execution circuitry 204 (e.g., via the user event identification circuitry 220) determines if the post-capture graphic the GUI is to be discontinued. If the user event identification circuitry 220 determines that the post-capture graphic is to not be discontinued, then the example instructions and/or operations 1300 return to block 1302. If the user event identification circuitry 220 determines that the post-capture graphic is to be discontinued, then the example instructions and/or operations 1300 return to block 1036 of FIG. 10.

FIG. 14 is a block diagram of an example processor platform 1400 structured to execute and/or instantiate the machine readable instructions and/or the operations of FIGS. 10-13 to implement the computing device 110 of FIG. 2. The processor platform 1400 can be, for example, a server, a personal computer, a workstation, a self-learning machine (e.g., a neural network), a mobile device (e.g., a cell phone, a smart phone, a tablet such as an iPad^{Tm}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs, microprocessors, CPUs, GPUs, DSPs, and/or microcontrollers from any desired family or manufacturer. The processor circuitry 1412 may be implemented by one or more semiconductor based (e.g., silicon based) devices. In this example, the processor circuitry 1412 implements the example user interface execution circuitry 204, the example communication interface circuitry 208, the example audio visual calibration circuitry 210, the example image sensor calibration circuitry 212, the example media processing circuitry 214, and the example viewpoint interpolation circuitry 215.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417.

The processor platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user to enter data and/or commands into the processor circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1432, which may be implemented by the machine readable instructions of FIGS. 10-13, may be stored in the mass storage device 1428, in the volatile memory 1414, in the non-volatile memory 1416, and/or on a removable non-transitory computer readable storage medium such as a CD or DVD.

FIG. 15 is a block diagram of an example implementation of the processor circuitry 1412 of FIG. 14. In this example, the processor circuitry 1412 of FIG. 14 is implemented by a general purpose microprocessor 1500. The general purpose microprocessor circuitry 1500 executes some or all of the machine readable instructions of the flowchart of FIGS. 10-13 to effectively instantiate the computing device 110 of FIG. 2 as logic circuits to perform the operations corresponding to those machine readable instructions. In some such examples, the circuitry of FIG. 2 is instantiated by the hardware circuits of the microprocessor 1500 in combination with the instructions. For example, the microprocessor 1500 may implement multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowcharts of FIGS. 10-13.

The cores 1502 may communicate by a first example bus 1504. In some examples, the first bus 1504 may implement a communication bus to effectuate communication associated with one(s) of the cores 1502. For example, the first bus 1504 may implement at least one of an Inter-Integrated Circuit (I2C) bus, a Serial Peripheral Interface (SPI) bus, a PCI bus, or a PCIe bus. Additionally or alternatively, the first bus 1504 may implement any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2_{—} cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the L1 cache 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating point operations. In yet other examples, the AL circuitry 1516 may include first AL circuitry that performs integer based operations and second AL circuitry that performs floating point operations. In some examples, the AL circuitry 1516 may be referred to as an Arithmetic Logic Unit (ALU). The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The second bus 1522 may implement at least one of an I2C bus, a SPI bus, a PCI bus, or a PCIe bus

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 16 is a block diagram of another example implementation of the processor circuitry 1412 of FIG. 14. In this example, the processor circuitry 1412 is implemented by FPGA circuitry 1600. The FPGA circuitry 1600 can be used, for example, to perform operations that could otherwise be performed by the example microprocessor 1500 of FIG. 5 executing corresponding machine readable instructions. However, once configured, the FPGA circuitry 1600 instantiates the machine readable instructions in hardware and, thus, can often execute the operations faster than they could be performed by a general purpose microprocessor executing the corresponding software.

More specifically, in contrast to the microprocessor 1500 of FIG. 5 described above (which is a general purpose device that may be programmed to execute some or all of the machine readable instructions represented by the flowcharts of FIGS. 10-13 but whose interconnections and logic circuitry are fixed once fabricated), the FPGA circuitry 1600 of the example of FIG. 16 includes interconnections and logic circuitry that may be configured and/or interconnected in different ways after fabrication to instantiate, for example, some or all of the machine readable instructions represented by the flowcharts of FIGS. 10-13. In particular, the FPGA 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the software represented by the flowcharts of FIGS. 10-13. As such, the FPGA circuitry 1600 may be structured to effectively instantiate some or all of the machine readable instructions of the flowcharts of FIGS. 10-13 as dedicated logic circuits to perform the operations corresponding to those software instructions in a dedicated manner analogous to an ASIC. Therefore, the FPGA circuitry 1600 may perform the operations corresponding to the some or all of the machine readable instructions of FIGS. 10-13 faster than the general purpose microprocessor can execute the same.

In the example of FIG. 16, the FPGA circuitry 1600 is structured to be programmed (and/or reprogrammed one or more times) by an end user by a hardware description language (HDL) such as Verilog. The FPGA circuitry 1600 of FIG. 16, includes example input/output (I/O) circuitry 1602 to obtain and/or output data to/from example configuration circuitry 1604 and/or external hardware (e.g., external hardware circuitry) 1606. For example, the configuration circuitry 1604 may implement interface circuitry that may obtain machine readable instructions to configure the FPGA circuitry 1600, or portion(s) thereof. In some such examples, the configuration circuitry 1604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may implement the microprocessor 1500 of FIG. 5. The FPGA circuitry 1600 also includes an array of example logic gate circuitry 1608, a plurality of example configurable interconnections 1610, and example storage circuitry 1612. The logic gate circuitry 1608 and interconnections 1610 are configurable to instantiate one or more operations that may correspond to at least some of the machine readable instructions of FIGS. 10-13 and/or other desired operations. The logic gate circuitry 1608 shown in FIG. 16 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations. The logic gate circuitry 1608 may include other electrical structures such as look-up tables (LUTs), registers (e.g., flip-flops or latches), multiplexers, etc.

The interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example Dedicated Operations Circuitry 1614. In this example, the Dedicated Operations Circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processor circuitry 1412 of FIG. 14, many other approaches are contemplated. For example, as mentioned above, modern FPGA circuitry may include an on-board CPU, such as one or more of the example CPU 1620 of FIG. 16. Therefore, the processor circuitry 1412 of FIG. 14 may additionally be implemented by combining the example microprocessor 1500 of FIG. 15 and the example FPGA circuitry 1600 of FIG. 16. In some such hybrid examples, a first portion of the machine readable instructions represented by the flowcharts of FIGS. 10-13 may be executed by one or more of the cores 1502 of FIG. 15, a second portion of the machine readable instructions represented by the flowcharts of FIGS. 10-13 may be executed by the FPGA circuitry 1600 of FIG. 16, and/or a third portion of the machine readable instructions represented by the flowcharts of FIGS. 10-13 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1412 of FIG. 14 may be in one or more packages. For example, the processor circuitry 1500 of FIG. 15 and/or the FPGA circuitry 1600 of FIG. 16 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

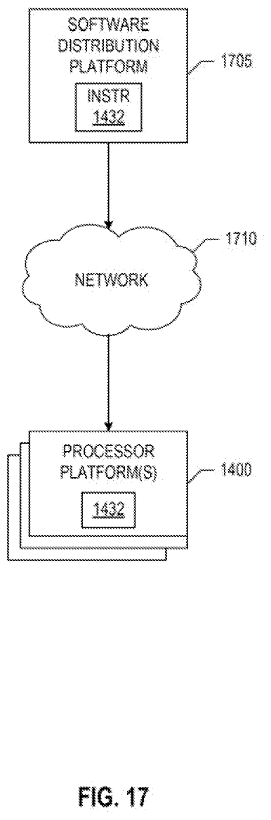

A block diagram illustrating an example software distribution platform 1705 to distribute software such as the example machine readable instructions 1432 of FIG. 14 to hardware devices owned and/or operated by third parties is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14 . The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions 1000-1300 of FIGS. 10-13, as described above. The one or more servers of the example software distribution platform 1705 are in communication with a network 1710, which may correspond to any one or more of the Internet and/or any of the example networks (e.g., network 202 of FIG. 2) described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions 1000-1300 of FIGS. 10-13, may be downloaded to the example processor platform 1400, which is to execute the machine readable instructions 1432 to implement the computing device 110 of FIG. 2. In some example, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices.

From the foregoing, it will be appreciated that example systems, methods, apparatus, and articles of manufacture have been disclosed that enable a graphical user interface to cause a set-up of a scene that is to be captured to enable the generation of variable viewpoint media. Disclosed systems, methods, apparatus, and articles of manufacture improve the efficiency of using a computing device by enabling the graphical user interface to cause a pivot axis within a region of interest in the scene to be aligned with an object of the scene. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to facilitate generation of variable viewpoint media are disclosed herein. Further examples and combinations thereof include the following:

Example 1 includes an apparatus comprising at least one memory, instructions, and processor circuitry to execute the instructions to cause display of first image data of a real-world scene captured by a first image sensor, the first image data providing a first perspective of the scene, cause display of second image data of the scene captured by a second image sensor, the second image providing a second perspective of the scene, the second perspective different than the first perspective based on different positions of the first and second cameras relative to the scene, cause display of a pivot axis line superimposed on at least one of the first image data or the second image data, the pivot axis line to indicate a point of rotation, within the scene, of variable viewpoint media to be generated based on image data captured by the first and second image sensors, and cause the first and second image sensors to capture the image data for the variable viewpoint visual media.

In Example 2, the subject matter of Example 1 can optionally include that the first and second image sensors are included in an array of image sensors, the array of image sensors supported in fixed spatial relationship by a framework.

In Example 3, the subject matter of Examples 1-2 can optionally include that the array of image sensors includes additional image sensors other than the first image sensor, the second image sensor, and a third image sensor, and the processor circuitry is to cause display of an array of image sensor icons, the array of image sensor icons including first, second, and third image sensor icons respectively representative of the first, second, and third image sensors, the array of image sensor icons including additional image sensor icons, different ones of the additional image sensor icons representative of different ones of the additional image sensors, the first, second, and third image sensor icons including a visual indicator to indicate the images captured by the first, second, and third sensors are being displayed, and in response to user selection of one of the additional image sensors in place of the third image sensor, remove the visual indicator from the third image sensor icon and modify the one of the additional image sensor icons to include the visual indicator.

In Example 4, the subject matter of Examples 1-3 can optionally include that the processor circuitry is to cause display of third image data of the scene captured by a third image sensor, the third image data providing a third perspective of the scene different than the first perspective and different than the second perspective.

In Example 5, the subject matter of Examples 1-4 can optionally include that at least one of the first image data, the second image data, or the third image data corresponds to a cropped portion of full-frame image data, and, in response to user input indicating a change in a position of the point of rotation within the scene relative to the first, second, and third image sensors, the processor circuity is to adjust an area of the at least first image data, the second image data, or the third image data that corresponds to the cropped portion, and adjust placement of the pivot axis line.

In Example 6, the subject matter of Examples 1-5 can optionally include that the first image sensor is to be between the second and third image sensors, the first image data to be displayed between the second and third image data with the second image data on a first side of the first image data and the third image data on a second side of the first image data, and, in response to user input indicating a switch between a first perspective mode and a second perspective mode, the processor circuitry is to swap positions of the second and third image data such that the second image data is displayed on the second side of the first image data and the third image data is displayed on the first side of the first image data, and invert the first and second image data.

In Example 7, the subject matter of Examples 1-6 can optionally include that the second and third image data have a trapezoidal shape that changes in response to the switch from the first perspective mode to the second perspective mode, proximate edges of the second and third image data to be smaller than distal edges of the second and third image data in the first perspective mode, the proximate edges to be larger than the distal edges in the second perspective mode, the proximate edges to be closest to the first image data, the distal edges to be farthest from the first image data.

In Example 8, the subject matter of Examples 1-7 can optionally include that the processor circuitry is to cause display of a preview animation, the preview animation including presentation of successive ones of image frames in the image data synchronously captured by the first and second image sensors.

In Example 9, the subject matter of Examples 1-8 can optionally include that the processor circuitry is to cause display of the image data captured for the variable viewpoint media from at least one of the first perspective or the second perspective, or an additional perspective based on user input indicating a change in perspective during display of the image data, the additional perspective corresponding to an additional image sensor in an array of image sensors.

Example 10 includes at least one non-transitory computer-readable storage medium comprising instructions that, when executed, cause processor circuitry to at least cause display of first image data of a real-world scene captured by a first image sensor, the first image data providing a first perspective of the scene, cause display of second image data of the scene captured by a second image sensor, the second image providing a second perspective of the scene, the second perspective different than the first perspective based on different positions of the first and second cameras relative to the scene, cause display of a pivot axis line superimposed on at least one of the first image data or the second image data, the pivot axis line to indicate a point of rotation, within the scene, of variable viewpoint media to be generated based on image data captured by the first and second image sensors, and cause the first and second image sensors to capture the image data for the variable viewpoint media.

In Example 11, the subject matter of Example 10 can optionally include that the first and second image sensors are included in an array of image sensors, the array of image sensors supported in fixed spatial relationship by a framework.

In Example 12, the subject matter of Examples 10-11 can optionally include that the array of image sensors includes additional image sensors other than the first image sensor, the second image sensor, and a third image sensor, and the instructions are to cause display of an array of image sensor icons, the array of image sensor icons including first, second, and third image sensor icons respectively representative of the first, second, and third image sensors, the array of image sensor icons including additional image sensor icons, different ones of the additional image sensor icons representative of different ones of the additional image sensors, the first, second, and third image sensor icons including a visual indicator to indicate the images captured by the first, second, and third sensors are being displayed, and in response to user selection of one of the additional image sensors in place of the third image sensor, remove the visual indicator from the third image sensor icon and modify the one of the additional image sensor icons to include the visual indicator.

In Example 13, the subject matter of Examples 10-12 can optionally include that the instructions are to cause display of third image data of the scene captured by a third image sensor, the third image data providing a third perspective of the scene different than the first perspective and different than the second perspective.

In Example 14, the subject matter of Examples 10-13 can optionally include that at least one of the first image data, the second image data, or the third image data corresponds to a cropped portion of full-frame image data, and, in response to user input indicating a change in a position of the point of rotation within the scene relative to the first, second, and third image sensors, the instructions are to adjust an area of the at least first image data, the second image data, or the third image data that corresponds to the cropped portion, and adjust placement of the pivot axis line.

In Example 15, the subject matter of Examples 10-14 can optionally include that the first image sensor is to be between the second and third image sensors, the first image data to be displayed between the second and third image data with the second image data on a first side of the first image data and the third image data on a second side of the first image data, and, in response to user input indicating a switch between a first perspective mode and a second perspective mode, the instructions are to swap positions of the second and third image data such that the second image data is displayed on the second side of the first image data and the third image data is displayed on the first side of the first image data, and invert the first and second image data.

In Example 16, the subject matter of Examples 10-15 can optionally include that the second and third image data have a trapezoidal shape that changes in response to the switch from the first perspective mode to the second perspective mode, proximate edges of the second and third image data to be smaller than distal edges of the second and third image data in the first perspective mode, the proximate edges to be larger than the distal edges in the second perspective mode, the proximate edges to be closest to the first image data, the distal edges to be farthest from the first image data.

In Example 17, the subject matter of Examples 10-16 can optionally include that the instructions are to cause display of a preview animation, the preview animation including presentation of successive ones of image frames in the image data synchronously captured by the first and second image sensors.

In Example 18, the subject matter of Examples 10-17 can optionally include that the instructions are to cause display of the image data for the variable viewpoint media from at least one of the first perspective or the second perspective, or an additional perspective based on user input indicating a change in perspective during display of the image data, the additional perspective corresponding to an additional image sensor in an array of image sensors.

Example 19 includes a method comprising displaying first image data of a real-world scene captured by a first image sensor, the first image data providing a first perspective of the scene, displaying second image data of the scene captured by a second image sensor, the second image providing a second perspective of the scene, the second perspective different than the first perspective based on different positions of the first and second cameras relative to the scene, displaying a pivot axis line superimposed on at least one of the first image data or the second image data, the pivot axis line to indicate a point of rotation, within the scene, of variable viewpoint media to be generated based on image data captured by the first and second image sensors, and capturing the image data for the variable viewpoint media.

In Example 20, the subject matter of Example 19 can optionally include that the first and second image sensors are included in an array of image sensors, the array of image sensors supported in fixed spatial relationship by a framework.

In Example 21, the subject matter of Examples 19-20 can optionally include that the array of image sensors includes additional image sensors other than the first image sensor, the second image sensor, and a third image sensor, further including displaying an array of image sensor icons, the array of image sensor icons including first, second, and third image sensor icons respectively representative of the first, second, and third image sensors, the array of image sensor icons including additional image sensor icons, different ones of the additional image sensor icons representative of different ones of the additional image sensors, the first, second, and third image sensor icons including a visual indicator to indicate the images captured by the first, second, and third sensors are being displayed, and in response to user selection of one of the additional image sensors in place of the third image sensor, removing the visual indicator from the third image sensor icon and modify the one of the additional image sensor icons to include the visual indicator.

In Example 22, the subject matter of Examples 19-21 can optionally include that displaying third image data of the scene captured by a third image sensor, the third image data providing a third perspective of the scene different than the first perspective and different than the second perspective.

In Example 23, the subject matter of Examples 19-22 can optionally include that at least one of the first image data, the second image data, or the third image data corresponds to a cropped portion of full-frame image data, and, in response to user input indicating a change in a position of the point of rotation within the scene relative to the first, second, and third image sensors, further including adjusting an area of the at least first image data, the second image data, or the third image data that corresponds to the cropped portion, and adjusting placement of the pivot axis line.

In Example 24, the subject matter of Examples 19-23 can optionally include that the first image sensor is to be between the second and third image sensors, the first image data to be displayed between the second and third image data with the second image data on a first side of the first image data and the third image data on a second side of the first image data, and, in response to user input indicating a switch between a first perspective mode and a second perspective mode, further including swapping positions of the second and third image data such that the second image data is displayed on the second side of the first image data and the third image data is displayed on the first side of the first image data, and inverting the first and second image data.

In Example 25, the subject matter of Examples 19-24 can optionally include that the second and third image data have a trapezoidal shape that changes in response to the switch from the first perspective mode to the second perspective mode, proximate edges of the second and third image data to be smaller than distal edges of the second and third image data in the first perspective mode, the proximate edges to be larger than the distal edges in the second perspective mode, the proximate edges to be closest to the first image data, the distal edges to be farthest from the first image data.

In Example 26, the subject matter of Examples 19-25 can optionally include that displaying a preview animation, the preview animation including presentation of successive ones of image frames in the image data synchronously captured by the first and second image sensors.

In Example 27, the subject matter of Examples 19-26 can optionally include that displaying the image data for the variable viewpoint media from at least one of the first perspective or the second perspective, or an additional perspective based on user input indicating a change in perspective during display of the image data, the additional perspectives corresponding to an additional image sensor in an array of image sensors.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The status of the claims:

1. An apparatus comprising:
at least one memory;
instructions; and
processor circuitry to execute the instructions to:
cause display of first image data of a real-world scene captured by a first image sensor, the first image data providing a first perspective of the scene;
cause display of second image data of the scene captured by a second image sensor, the second image providing a second perspective of the scene, the second perspective different than the first perspective based on different positions of the first and second cameras relative to the scene;
cause display of a pivot axis line superimposed on at least one of the first image data or the second image data, the pivot axis line to indicate a point of rotation, within the scene, of variable viewpoint media to be generated based on image data captured by the first and second image sensors; and
cause the first and second image sensors to capture the image data for the variable viewpoint visual media.

2. The apparatus of claim 1, wherein the first and second image sensors are included in an array of image sensors, the array of image sensors supported in fixed spatial relationship by a framework.

3. The apparatus of claim 2, wherein the array of image sensors includes additional image sensors other than the first image sensor, the second image sensor, and a third image sensor, and the processor circuitry is to:
cause display of an array of image sensor icons, the array of image sensor icons including first, second, and third image sensor icons respectively representative of the first, second, and third image sensors, the array of image sensor icons including additional image sensor icons, different ones of the additional image sensor icons representative of different ones of the additional image sensors, the first, second, and third image sensor icons including a visual indicator to indicate the images captured by the first, second, and third sensors are being displayed; and
in response to user selection of one of the additional image sensors in place of the third image sensor, remove the visual indicator from the third image sensor icon and modify the one of the additional image sensor icons to include the visual indicator.

4. The apparatus of claim 1, wherein the processor circuitry is to cause display of third image data of the scene captured by a third image sensor, the third image data providing a third perspective of the scene different than the first perspective and different than the second perspective.

5. The apparatus of claim 4, wherein at least one of the first image data, the second image data, or the third image data corresponds to a cropped portion of full-frame image data, and, in response to user input indicating a change in a position of the point of rotation within the scene relative to the first, second, and third image sensors, the processor circuity is to:
adjust an area of the at least first image data, the second image data, or the third image data that corresponds to the cropped portion; and
adjust placement of the pivot axis line.

6. The apparatus of claim 4, wherein the first image sensor is to be between the second and third image sensors, the first image data to be displayed between the second and third image data with the second image data on a first side of the first image data and the third image data on a second side of the first image data, and, in response to user input indicating a switch between a first perspective mode and a second perspective mode, the processor circuitry is to:
swap positions of the second and third image data such that the second image data is displayed on the second side of the first image data and the third image data is displayed on the first side of the first image data; and
invert the first and second image data.

7. The apparatus of claim 6, wherein the second and third image data have a trapezoidal shape that changes in response to the switch from the first perspective mode to the second perspective mode, proximate edges of the second and third image data to be smaller than distal edges of the second and third image data in the first perspective mode, the proximate edges to be larger than the distal edges in the second perspective mode, the proximate edges to be closest to the first image data, the distal edges to be farthest from the first image data.

8. The apparatus of claim 1, wherein the processor circuitry is to cause display of a preview animation, the preview animation including presentation of successive ones of image frames in the image data synchronously captured by the first and second image sensors.

9. The apparatus of claim 1, wherein the processor circuitry is to cause display of the image data captured for the variable viewpoint media from at least one of the first perspective or the second perspective, or an additional perspective based on user input indicating a change in perspective during display of the image data, the additional perspective corresponding to an additional image sensor in an array of image sensors.

10. At least one non-transitory computer-readable storage medium comprising instructions that, when executed, cause processor circuitry to at least:
cause display of first image data of a real-world scene captured by a first image sensor, the first image data providing a first perspective of the scene;
cause display of second image data of the scene captured by a second image sensor, the second image providing a second perspective of the scene, the second perspective different than the first perspective based on different positions of the first and second cameras relative to the scene;
cause display of a pivot axis line superimposed on at least one of the first image data or the second image data, the pivot axis line to indicate a point of rotation, within the scene, of variable viewpoint media to be generated based on image data captured by the first and second image sensors; and
cause the first and second image sensors to capture the image data for the variable viewpoint media.

11. The at least one non-transitory computer-readable medium of claim 10, wherein the first and second image sensors are included in an array of image sensors, the array of image sensors supported in fixed spatial relationship by a framework.

12. The at least one non-transitory computer-readable medium of claim 11, wherein the array of image sensors includes additional image sensors other than the first image sensor, the second image sensor, and a third image sensor, and the instructions are to:
cause display of an array of image sensor icons, the array of image sensor icons including first, second, and third image sensor icons respectively representative of the first, second, and third image sensors, the array of image sensor icons including additional image sensor icons, different ones of the additional image sensor icons representative of different ones of the additional image sensors, the first, second, and third image sensor icons including a visual indicator to indicate the images captured by the first, second, and third sensors are being displayed; and
in response to user selection of one of the additional image sensors in place of the third image sensor, remove the visual indicator from the third image sensor icon and modify the one of the additional image sensor icons to include the visual indicator.

13. The at least one non-transitory computer-readable medium of claim 10, wherein the instructions are to cause display of third image data of the scene captured by a third image sensor, the third image data providing a third perspective of the scene different than the first perspective and different than the second perspective.

14. The at least one non-transitory computer-readable medium of claim 13, wherein at least one of the first image data, the second image data, or the third image data corresponds to a cropped portion of full-frame image data, and, in response to user input indicating a change in a position of the point of rotation within the scene relative to the first, second, and third image sensors, the instructions are to:
adjust an area of the at least first image data, the second image data, or the third image data that corresponds to the cropped portion; and
adjust placement of the pivot axis line.

15. The at least one non-transitory computer-readable medium of claim 13, wherein the first image sensor is to be between the second and third image sensors, the first image data to be displayed between the second and third image data with the second image data on a first side of the first image data and the third image data on a second side of the first image data, and, in response to user input indicating a switch between a first perspective mode and a second perspective mode, the instructions are to:
swap positions of the second and third image data such that the second image data is displayed on the second side of the first image data and the third image data is displayed on the first side of the first image data; and
invert the first and second image data.

16. The at least one non-transitory computer-readable medium of claim 15, wherein the second and third image data have a trapezoidal shape that changes in response to the switch from the first perspective mode to the second perspective mode, proximate edges of the second and third image data to be smaller than distal edges of the second and third image data in the first perspective mode, the proximate edges to be larger than the distal edges in the second perspective mode, the proximate edges to be closest to the first image data, the distal edges to be farthest from the first image data.

17. The at least one non-transitory computer-readable medium of claim 10, wherein the instructions are to cause display of a preview animation, the preview animation including presentation of successive ones of image frames in the image data synchronously captured by the first and second image sensors.

18. (canceled)

19. A method comprising:
displaying first image data of a real-world scene captured by a first image sensor, the first image data providing a first perspective of the scene;
displaying second image data of the scene captured by a second image sensor, the second image providing a second perspective of the scene, the second perspective different than the first perspective based on different positions of the first and second cameras relative to the scene;
displaying a pivot axis line superimposed on at least one of the first image data or the second image data, the pivot axis line to indicate a point of rotation, within the scene, of variable viewpoint media to be generated based on image data captured by the first and second image sensors; and
capturing the image data for the variable viewpoint media.

20. The method of claim 19, wherein the first and second image sensors are included in an array of image sensors, the array of image sensors supported in fixed spatial relationship by a framework.

21. The method of claim 20, wherein the array of image sensors includes additional image sensors other than the first image sensor, the second image sensor, and a third image sensor, further including:
displaying an array of image sensor icons, the array of image sensor icons including first, second, and third image sensor icons respectively representative of the first, second, and third image sensors, the array of image sensor icons including additional image sensor icons, different ones of the additional image sensor icons representative of different ones of the additional image sensors, the first, second, and third image sensor icons including a visual indicator to indicate the images captured by the first, second, and third sensors are being displayed; and
in response to user selection of one of the additional image sensors in place of the third image sensor, removing the visual indicator from the third image sensor icon and modify the one of the additional image sensor icons to include the visual indicator.

22. The method of claim 19, further including displaying third image data of the scene captured by a third image sensor, the third image data providing a third perspective of the scene different than the first perspective and different than the second perspective.

23. The method of claim 22, wherein at least one of the first image data, the second image data, or the third image data corresponds to a cropped portion of full-frame image data, and, in response to user input indicating a change in a position of the point of rotation within the scene relative to the first, second, and third image sensors, further including:
adjusting an area of the at least first image data, the second image data, or the third image data that corresponds to the cropped portion; and
adjusting placement of the pivot axis line.

24. The method of claim 22, wherein the first image sensor is to be between the second and third image sensors, the first image data to be displayed between the second and third image data with the second image data on a first side of the first image data and the third image data on a second side of the first image data, and, in response to user input indicating a switch between a first perspective mode and a second perspective mode, further including:
swapping positions of the second and third image data such that the second image data is displayed on the second side of the first image data and the third image data is displayed on the first side of the first image data; and
inverting the first and second image data.

25. The method of claim 24, wherein the second and third image data have a trapezoidal shape that changes in response to the switch from the first perspective mode to the second perspective mode, proximate edges of the second and third image data to be smaller than distal edges of the second and third image data in the first perspective mode, the proximate edges to be larger than the distal edges in the second perspective mode, the proximate edges to be closest to the first image data, the distal edges to be farthest from the first image data.

26. The method of claim 19, further including displaying a preview animation, the preview animation including presentation of successive ones of image frames in the image data synchronously captured by the first and second image sensors.

27. (canceled)
